(19) United States
(12) Patent Application Publication
(10) Pub. No.: US 2025/0242533 A1
(43) Pub. Date: Jul. 31, 2025

(54) SCREW ELEMENTS WITH IMPROVED MIXING AND DEGASSING EFFECT WITH REDUCED ENERGY INPUT

(71) Applicant: Covestro Deutschland AG, Leverkusen (DE)

(72) Inventors: Thomas Koenig, Leverkusen (DE); Michael Bierdel, Leverkusen (DE)

(21) Appl. No.: 18/855,221

(22) PCT Filed: Apr. 5, 2023
(86) PCT No.: PCT/EP2023/058951

§ 371 Date: Oct. 8, 2024

(30) Foreign Application Priority Data
Apr. 11, 2022 (EP) 22167637.2

(51) Int. Cl. B29C 48/40; B29C 48/405; B29C 48/65

(52) U.S. Cl. CPC B29C 48/402; B29C 48/405; B29C 48/65

(57) ABSTRACT

The present disclosure relates to a pair of screw elements suitable for a multishaft screw machine with m screw shafts SW₁ to SWₘ rotating in the same direction and at the same speed, the respective neighboring axes of rotation X₁ to Xₘ of which have a center distance A in a cross-section at right angles to the axes of rotation, and with m interpenetrating circular housing bores which each have an identical housing bore inner diameter D and of which the bore centers M₁ to Mₘ have a distance equal to the center distance A, and of which the bore centers M₁ to Mₘ coincide with the respective associated axes of rotation X₁ to Xₘ of the screw shafts SW₁ to SWₘ and coincide with the centers of rotation P₁ to Pₘ of the screw elements.

### CROSS REFERENCE TO RELATED APPLICATIONS

This application is a U.S. national stage application, filed under 35 U.S.C. § 371, of International Application No. PCT/EP2023/058951, which was filed on Apr. 5, 2023, and which claims priority to European Patent Application No. 22167637.2, which was filed on Apr. 11, 2022. The entire contents of each are hereby incorporated by reference into this specification.

### FIELD

The present invention relates to a pair of screw elements suitable for a multishaft screw machine
with m screw shafts SW₁ to SWₘ rotating in the same direction and at the same speed, the respective neighboring axes of rotation X₁ to Xₘ of which have a center distance A in a cross section at right angles to the axes of rotation
and
with m interpenetrating circular housing bores which each have an identical housing bore inner diameter D and of which the bore centers M₁ to Mₘ have a distance equal to the center distance A, and of which the bore centers M₁ to Mₘ coincide with the respective associated axes of rotation X₁ to Xₘ of the screw shafts SW₁ to SWₘ and coincide with the centers of rotation P₁ to Pₘ of the screw elements,
wherein the two screw elements of the pair of screw elements lie opposite each other on directly neighboring screw shafts,
wherein the two screw elements of the pair of screw elements scrape each other with a screw element-to-screw element clearance s,
wherein both screw elements have an asymmetrical screw profile,
wherein both screw elements each have exactly two crests,
wherein for each of the two screw elements, its two crests have different distances to the respective center of rotation P of the screw profile,
wherein in each case one crest has a distance D/2 reduced by a screw element-to-housing wall clearance δ and further reduced by an additional gap SP to the respective center of rotation P and the other crest has a distance D/2 reduced by a screw element-to-housing wall clearance δ, but not reduced by an additional gap SP, to the respective center of rotation P,
wherein the screw element-to-housing wall clearance δ is the same for both screw elements and the additional gap SP is the same for both screw elements,
wherein the sum of the crest angles of both screw elements BKW in radians satisfies the equation

$$BKW = f * BKGW \qquad ( 1 )$$

wherein for the factor f it is true that the factor f is greater than 0 and less than or equal to 0.95,
wherein BKGW is determined by:

$$BKGW = 2 ( π - \frac{1}{2} ( arccos ( \frac{{A}^{2} - 2 {RE}^{2}}{2 {RE}^{2}} ) + arccos ( \frac{{A}^{2} - 2 {RE}^{2} + 2 RE SP - {SP}^{2}}{2 RE ( RE - SP )} ) + arccos ( \frac{{A}^{2} - 2 {( RE - SP )}^{2}}{2 {( RE - SP )}^{2}} ) + arccos \frac{{A}^{2} - 2 {RE}^{2} + 2 RE SP - {SP}^{2}}{2 RE ( RE - SP )} ) ) - \frac{s}{T} ( 26.22113 - 16.03623 \frac{A}{D} - 30.9465 \frac{δ}{D} + 14.5763 \frac{s}{D} - 0.20071 \frac{T}{D} - 0.00475 \frac{SP}{GT} + 4.89626 erf ( - 0.855 \frac{T}{D} ) ) ) . \qquad ( 2 )$$

Here, the parameters required to represent a screw profile are listed below in table 1.

### BACKGROUND

In WO 2011/006516A1 an extruder is disclosed having a housing with at least two axially parallel shafts which can be driven in the same direction and are provided with at least double-flight conveying elements, which wipe each other off at a center distance with little clearance around the entire circumference, wherein there is a distance (a) between the crest of the at least one further gear and the inner wall of the housing.

A multishaft screw machine is known from EP0875356A2. The multishaft screw machine is provided with a housing, with two housing bores which are parallel to each other and partially penetrate each other, with two rotationally drivable shafts arranged in the housing bores, with screw elements mounted on the shafts for conjoint rotation and with kneading disks mounted on the shafts for conjoint rotation and meshing with each other, which are each narrower than the disk width (B) in their crest areas to form mixing and scraper projections located on the periphery.

Furthermore, DE 10 2008 016862 A1 describes an extruder with at least two axially parallel shafts which can be driven in the same direction and which has at least double-threaded conveying elements (2, 11, 12) which are in substantially close contact at one point (C).

EP 0 788 868 A1 describes a method and a device for mixing with continuous rolling of thermoplastic material. The apparatus comprises a mixing chamber and at least one pair of threaded shafts disposed within the mixing chamber (5), wherein the threaded shafts have at least a tip portion of the thread and at least a core portion of the thread which are countersunk asymmetrically with respect to the longitudinal axis of the shaft to create surfaces of the shafts and an empty space between the countersunk thread portion and the inner surface of the chamber to perform rolling of the material on at least a portion of the surface of the chamber itself during the supply of the material to the outlet of the mixing chamber.

Furthermore, WO 2016/107527 A1 discloses a self-cleaning extrusion device with two screws rotating in the same direction. The device consists of a screw mechanism, a cylinder, a feed opening, a vent opening and an outlet opening.

In the context of the present invention, a multishaft screw machine is understood to mean a screw machine having more than one screw shaft, for example a screw machine having two, three or four screw shafts or else a screw machine having eight to sixteen, especially twelve, screw shafts in an annular arrangement. In the case of more than two screw shafts, the axes of rotation of the screw shafts may be arranged next to one another, or else, for example—as in the case of what is called a ring extruder—in annular form. In multishaft extruders, the axes of rotation of the screw shafts are generally arranged parallel to each other. This parallel arrangement of the axes of rotation is also favored according to the invention. In this respect, the screw elements of the pair of screw elements according to the invention are preferably in a number that corresponds to the number of screw shafts of the respective extruder on which screw shafts are arranged directly opposite. Such a screw machine having more than one screw shaft is also referred to hereinafter as a multiple-shaft screw machine, multishaft screw machine or multishaft extruder. A twin-shaft screw machine is also referred to hereinafter as a twin-screw extruder. In the context of the present invention, the term “screw machine” is used synonymously with the term “extruder”. An extruded compound or compound to be extruded is also referred to below as an “extrudate”.

Preferably, the multishaft screw machine is a twin-screw extruder with two screw shafts SW₁ to SW₂ rotating in the same direction and at the same speed, with neighboring axes of rotation X₁ and X₂, bore centers M₁ and M₂ and centers of rotation P₁ and P₂.

In the context of the present invention, an extrudate is a plastic or viscoelastic compound, in particular selected from the group comprising the members:
suspensions, pastes, glass melts, unfired ceramics, metal melt, or plastics.

In the context of the present invention, plastics are especially understood to mean:
polymers, especially polymer melts or polymer solutions, and in turn especially melts or solutions of thermoplastic polymers or melts or solutions of elastomers, in particular rubbers.

The thermoplastic polymer used is preferably at least one from the group of polycarbonate, polyester carbonate, polyamide, polyester, in particular polybutylene terephthalate and polyethylene terephthalate, polylactide, polyether, thermoplastic polyurethane, polyacetal, fluoropolymer, in particular polyvinylidene fluoride, polyether sulfones, polyolefin, in particular polyethylene and polypropylene, polyimide, polyacrylate, in particular poly(methyl)methacrylate, polyphenylene oxide, polyphenylene sulfide, polyetherketone, polyaryletherketone, styrene polymers, in particular polystyrene, styrene copolymers, in particular styrene-acrylonitrile copolymer, acrylonitrile-butadiene-styrene block copolymers and polyvinyl chloride. Similarly preferably used are what are known as blends of the polymers listed, which a person skilled in the art understands to be a combination of two or more polymers. Particularly preferred are polycarbonate and mixtures containing polycarbonate, very particularly preferably polycarbonate, which are obtained, for example, by the interfacial process or the melt transesterification process.

The rubber used is preferably at least one from the group of styrene-butadiene rubber, natural rubber, butadiene rubber, isoprene rubber, ethylene-propylene-diene rubber, ethylene-propylene rubber, butadiene-acrylonitrile rubber, hydrogenated nitrile rubber, butyl rubber, halobutyl rubber, chloroprene rubber, ethylene-vinyl acetate rubber, polyurethane rubber, thermoplastic polyurethane, gutta-percha, arylate rubber, fluorinated rubber, silicone rubber, sulfide rubber and chlorosulfonyl polyethylene rubber. A combination of two or more of the rubbers listed, or a combination of one or more rubbers with one or more other plastics, is of course also possible.

These thermoplastics or rubbers may be used in pure form or as mixtures with fillers and reinforcers, such as in particular glass fibres, as mixtures with one another or with other polymers, or as mixtures with customary polymer additives.

In a preferred embodiment, additives are added to the plastic masses, in particular to the polymer melts and mixtures of polymer melts. Said additives may be added to the extruder in solid, liquid or solution form together with the polymer, or else at least some or all of the additives are fed to the extruder via a side stream.

Additives can provide a polymer with a wide variety of properties. Said additives may, for example, be colourants, pigments, processing aids, fillers, antioxidants, reinforcers, UV absorbers and light stabilizers, metal deactivators, peroxide scavengers, basic stabilizers, nucleating agents, benzofurans and indolinones which have a stabilizing or antioxidant action, mould release agents, flame retardant additives, antistatic agents, dyes and melt stabilizers. Examples of these are carbon black, glass fibres, clay, mica, graphite fibres, titanium dioxide, carbon fibres, carbon nanotubes, ionic liquids and natural fibres.

In the context of the present invention, an asymmetrical cross-sectional screw profile is distinguished by the fact that there is no mirror axis or axis of rotation through any point in the plane of the cross-sectional screw profile that can be used to generate a cross-sectional screw profile congruent with an original cross-sectional screw profile; there is preferably no mirror axis through any point within a cross-sectional screw profile, particularly preferably no mirror axis through the structural center KP of the cross-sectional screw profile, that can be used to generate a profile congruent with the original profile. In this case, the structural center KP is the point within the cross-sectional screw profile which is the center of all circular arcs that form flight lands and grooves. In the context of the present invention, the structural center KP of a screw profile coincides with the center of rotation P of this screw profile. For example, EP 0002131 A1, FIG. 5 (A) or FIG. 5 (B), shows the screw profiles of a pair of screw elements which are asymmetrical in the sense of the present invention. The screw profiles of a pair of screw elements shown in EP 0002131 A1, FIG. 5 (A) or FIG. 5 (B), also have the property that they are not congruent, but can be merged into one another by mirroring the axes and rotating them.

A screw cross-sectional profile, also referred to as a screw profile for short in the context of the present invention, is understood to mean the outer contour of a screw element in a plane section at right angles to the axis of rotation of the screw element. Rules for generating precisely scraping screw profiles are described, for example, in [1]([1]=Klemens Kohlgruber: “Der gleichlåufige Doppelschneckenextruder” [Codirectional Twin-Screw Extruders], 2nd Edition, Hanser Verlag Munich 2016, pages 107 to 120). It is also described here that a given screw profile on a first shaft of a twin-screw extruder determines the screw profile on a second shaft of the twin-screw extruder immediately neighboring the first shaft ([1], page 108). The screw profile on the first shaft is therefore referred to as the generating screw profile. The screw profile on the second shaft follows from the screw profile of the first shaft of the twin-screw extruder and is therefore referred to as the generated screw profile.

Co-rotating twin-screw machines of which the screw shafts scrape each other precisely have been known for a long time, e.g. from DE 862 668 C. In polymer production and processing, screw machines with screw shafts of which the screw elements are based on the principle of precisely scraping screw cross-sectional profiles have been used in a variety of ways. This is mainly due to the fact that polymer melts adhere to surfaces and degrade over time at normal processing temperatures, which is prevented by the self-cleaning effect of screw elements in multishaft machines that precisely scrape each other in pairs.

In a multishaft extruder, the screw element with the generating screw profile and the screw element with the generated screw profile are always used alternately on neighboring shafts.

Two things need to be distinguished here: The precisely scraping screw profile, a mathematical construct in which two screw elements, which lie opposite each other on two immediately neighboring screw shafts, scrape each other with a screw element-to-screw element clearance s running towards zero, and screw profiles for screw elements designed in material reality for the intended use, i.e. technically executed screw elements. If the term “precisely scraping” is used in the context of the present invention, this means—unless otherwise stated—the mathematical construct of a precisely scraping screw profile or the corresponding screw element having this screw profile. If the term “practically scraping” or “executed” is used in the context of the present invention, this means—unless otherwise explained—the technically executed screw element or its screw profile, wherein this practically scraping screw profile has been derived from an exactly scraping screw profile, preferably by applying one of the clearance strategies: center distance increase, longitudinal section equidistant, spatial equidistant or circular equidistant, as explained in more detail below.

A person skilled in the art of screw elements will of course understand that a single screw element or screw profile on its own cannot be precisely scraping or practically scraping, but that a pair of such elements is always required.

Modern extruders have a modular system in which various screw elements can be mounted on a core shaft to form a screw shaft; such a screw shaft is therefore segmented. This allows a person skilled in the art to adapt the extruder to the respective process task. However, a screw shaft can also be made in one piece, i.e. can have only one screw element that extends substantially over the entire length of the screw shaft, or can be only partially segmented. The present invention relates both to screw elements that can be mounted on a core shaft and to the screw shafts made from a single piece described above.

Multishaft extruders, especially twin-screw extruders, are known to transfer mechanical energy into an extrudate by dissipation. This has desirable and undesirable consequences because, on the one hand, the energy input is required to fulfil process engineering tasks such as mixing and degassing and, on the other hand, the mechanical energy input is consumed and also leads to temperature increases in the extrudate, which can lead to undesirable chemical reactions that damage the extrudate.

Mixing is also known to be a basic operation in multishaft extruders, especially twin-screw extruders. Inhomogeneities in the extrudate due to imperfect mixing are known to lead to problems in the further processing of the extrudate and in the final properties.

Degassing, i.e. the removal of volatile components, is also known to be a basic operation on multishaft extruders, in particular twin-screw extruders, as described in [1], pages 494 to 525, for example. For degassing processes, the highest possible efficiency in degassing with low energy input is desirable in order to achieve economically high throughputs and good extrudate quality. Such processes are described, in addition to generally in [1], for example also in WO2010139413A1 [2], which describes a device and process for degassing polycarbonate solutions containing solvents.

For degassing, a polymer is transported as an extrudate in a partially filled portion past a degassing opening. Through the opening, volatile components such as by-products, monomers, oligomers, solvents or degradation products of the polymer formed during polycondensation reactions can be removed by the influence of temperature, water, oxygen or other components. To improve the removal of volatile components, the pressure in the degassing opening is lowered compared to the ambient pressure, depending on the degassing task. In [1], pages 494 to 525, it is also described that bubble formation and thus foaming of polymer melts is useful for residual degassing because it creates an inner surface that improves mass transfer. Foaming requires a sufficiently high overpressure of volatile components in the polymer, about 1 bar. The effect of shear on the polymer can promote bubble formation, which improves the degassing effect.

In a twin-screw extruder, the extrudate is sheared particularly strongly between a screw crest and the inner wall of the extruder housing bore. This means that a particularly large amount of energy is dissipated into the extrudate, which leads to strong localized overheating in the extrudate. This is shown, for example, in [1] on pages 416 to 423, images 4.80 to 4.84. This local overheating can lead to damage in the extrudate, such as changes in odor, color, chemical composition or molecular weight or to the formation of inhomogeneities in the extrudate such as gel bodies or specks. In particular, a large crest angle and especially a large sum of the crest angles of a pair of screw elements that lie opposite each other on directly neighboring screw shafts and scrape each other is detrimental.

Now there is a contradiction between the requirements of degassing or dispersion, both of which require shearing, and the avoidance of damage to the extrudate. It would be advantageous to combine the requirements of degassing or dispersion with those of extrudate protection in such a way that optimum degassing or dispersion is achieved with minimum damage to the extrudate. Furthermore, it is not conducive to either degassing or dispersion if the same proportion of a total quantity of extrudate is sheared again and again, because the extrudate exchange at the inner wall of the extruder housing bore is only slight.

The problem of extrudate damage and energy input can be solved, for example, as in WO2009152973A1 [3], in which screw elements for multishaft screw machines with screw shafts that scrape exactly in pairs in the same direction, with two or more screw flights Z, with center distance A and outer diameter DE, wherein the sum of the crest angles of a pair of screw elements is greater than 0 and less than

$$2 π - 4 Z arccos ( \frac{A}{DE} ) \qquad ( 3 )$$

and their use are described. Such screw elements are also preferably used in the extruders disclosed in [2]. However, the use of such screw elements does not improve the degassing effect.

U.S. Pat. No. 4,131,371 A [4] describes eccentric, practically mutually scraping conveying screw elements that rotate in the same direction, with eccentric profiles of which the crests are at different distances from the housing. This achieves an even load on the extrudate by spreading it out on the wall, providing more surface area for heat and mass transfer. An improvement in the degassing effect can possibly be achieved in this way. The aspect of wide crests and the associated disadvantages is not addressed.

EP 0002131 A1 [5] describes eccentric, asymmetrical screw elements that practically scrape each other, in which one crest of a respective screw element has a smaller distance to the housing bore inner wall of an extruder than the other crest or crests of the respective screw element. The main effect described there is the exchange of material between the housing bores of the extruder and a uniform, intensive shear. These screw elements have, with Z≥2 flights, Z crests and Z grooves. The screw element-to-screw element clearance s—i.e. the distance between the screw profiles of the screw elements of a pair of screw elements that are opposite each other on two directly neighboring screw shafts—is not taken into account.

It can be deduced from [5] that the sum of the crest angles SKW0 of each screw element of a pair of screw elements, in which the two screw elements scrape each other exactly, is

$$SKW 0 = π - \frac{1}{2} ( arccos ( \frac{{A}^{2} - 2 {RA}^{2}}{2 {RA}^{2}} ) + arccos ( \frac{{A}^{2} - 2 {RA}^{2} + 2 RA SP - {SP}^{2}}{2 RA ( RA - SP )} ) + arccos ( \frac{{A}^{2} - 2 {( RA - SP )}^{2}}{2 {( RA - SP )}^{2}} ) + arccos \frac{{A}^{2} - 2 {RA}^{2} + 2 RA SP - {SP}^{2}}{2 RA ( RA - SP )} ) ) \qquad ( 4 )$$

wherein numerous mathematically equivalent formulations are possible.

A person skilled in the art is aware, and it is stated for example in [1], on pages 39 to 41 and on pages 113 to 121, that technically designed screw elements must have clearances—both screw element-to-screw element clearances s and screw element-to-housing wall clearances δ—in order to ensure the functionality of the extruder. This is necessary to avoid metallic “seizure”, manufacturing tolerances, roughness, angular deviations, uneven thermal expansion and excessive extrudate stress due to insufficient spacing between two screw elements that are directly adjacent to each other on two directly neighboring screw shafts. The pages mentioned also explain methods for determining the exact geometry of the element to be produced from the clearances and the precisely scraping contour. These methods are called clearance strategies.

The strategies of longitudinal section equidistant, circular equidistant and spatial equidistant are also referred to below as the longitudinal section equidistant calculation rule, circular equidistant calculation rule and spatial equidistant calculation rule. Another clearance strategy is to increase the center distance according to [1], pages 40 and 41.

The spatial equidistant is mentioned, for example, in [1], pages 40 and 41. A spatial equidistant can be obtained, for example, starting from a parameter representation \vec{r}ₑ(a, b) of the outer surface of a precisely scraping screw element, wherein a and b are parameters to be selected according to the equation describing the outer surface \vec{r}ₑ of the relevant precisely scraping screw element. Some examples of how such a parameter display can look will be described hereinafter.

For the following considerations, a Cartesian coordinate system is assumed here, in which the coordinate along the axis of rotation of the extruder is designated as z and x and y are the coordinates in the plane perpendicular to the axis of rotation that intersects this plane at x=0, y=0 and z=0:

For example, in the case of a pair of screw elements in which the two screw elements face each other on two immediately neighboring screw shafts and precisely scrape each other, the screw profile of each of the two screw elements in the x-y-plane, wherein the respective axis of rotation X coincides with the z-axis, and the distance to the axis of rotation rₑ(γ) is specified as a 2 π periodic function of the screw profile of the angle γ to the x-axis, can be reproduced by a representation of the exactly scraping screw element profile according to the following equation (5).

$$( \begin{matrix}{x}_{e} \\ {y}_{e}\end{matrix} ) = ( \begin{matrix}{r}_{e} ( γ ) cos γ \\ {r}_{e} ( γ ) sin γ\end{matrix} ) \qquad ( 5 )$$

In such a case, a=γ and b=z can be selected.

Such a pair of screw elements can, for example, be shaped as a pair of conveying elements or as a pair of kneading disks.

In order to construct conveying elements, the screw profile is continued helically in the plane in order to obtain the limiting surface of a precisely scraping screw element. For a screw element with the pitch T, the following results with the z-coordinate as additional parameter.

$${\vec{r}}_{e} ( γ , z ) = ( \begin{matrix}r ( γ ) ( cos ( \pm \frac{2 π z}{T} ) cos γ - sin ( \pm \frac{2 π z}{T} ) sin γ ) \\ r ( γ ) ( cos ( \pm \frac{2 π z}{T} ) sin γ + sin ( \pm \frac{2 π z}{T} ) cos γ ) \\ z\end{matrix} ) \qquad ( 6 )$$

The positive sign indicates a clockwise-rotating screw profile, the negative sign indicates an counterclockwise-rotating screw profile.

With kneading disks, the screw profile is displaced into space along the z-axis, so that

$${\vec{r}}_{e} ( γ , z ) = ( \begin{matrix}r ( γ ) cos γ \\ r ( γ ) sin γ \\ z\end{matrix} ) \qquad ( 7 )$$

results.

If a screw profile, for example a precisely scraping screw profile, is constructed in the plane in sections via circular arcs i with the center coordinates

$$( \begin{matrix}{xm}_{i} \\ {xm}_{i}\end{matrix} )$$

and the radius rᵢ and β is an angle for the valid values of which the circular arc represents an exactly truncating helical profile, the circular arc can be described by

$$( \begin{matrix}x \\ y\end{matrix} ) = ( \begin{matrix}{xm}_{i} \\ {ym}_{i}\end{matrix} ) + {r}_{i} ( \begin{matrix}cos β \\ sin β\end{matrix} ) \qquad ( 8 )$$

The following then applies for the representation of a limiting surface of a precisely scraping conveying element in space

$${\vec{r}}_{e , i} ( β , z ) = ( \begin{matrix}cos ( \pm \frac{2 π z}{T} ) ( {xm}_{i} + {r}_{i} cos β ) - sin ( \pm \frac{2 π z}{T} ) ( {ym}_{i} + {r}_{i} sin β ) \\ sin ( \pm \frac{2 π z}{T} ) ( {xm}_{i} + {r}_{i} cos β ) + cos ( \pm \frac{2 π z}{T} ) ( {ym}_{i} + {r}_{i} sin β ) \\ z\end{matrix} ) \qquad ( 9 )$$

and, correspondingly, for the representation of a limiting surface of a precisely scraping kneading disk

$${\vec{r}}_{e , i} ( β , z ) = ( \begin{matrix}{xm}_{i} + {r}_{i} cos β \\ {ym}_{i} + {r}_{i} sin β \\ z\end{matrix} ) \qquad ( 10 )$$

In a conveying element, the pitch T of a screw element is the axial length required for a complete rotation of the screw profile of the screw element.

When calculating a screw profile in which, starting from a pair of screw elements with exactly scraping screw profiles, the screw profiles of a pair of practically scraping screw elements are determined taking into account the screw element-to-screw element clearance s, the spatial equidistant calculation rule can be applied, for example, after defining a parameter representation \vec{r}ₑ(a, b) as follows: At the point \vec{r}ₑ(a, b) the corresponding normal vector

$${\vec{n}}_{e} ( a , b ) = \pm \frac{\frac{\partial {\vec{r}}_{e}}{\partial a} \times \frac{\partial {\vec{r}}_{e}}{\partial b}}{\vert \frac{\partial {\vec{r}}_{e}}{\partial a} \times \frac{\partial {\vec{r}}_{e}}{\partial b} \vert} \qquad ( 11 )$$

is formed, wherein the sign is selected such that \vec{n}ₑ points outwards away from the axis of rotation. The outer surface \vec{r}_{f} of the technically designed screw element to be manufactured then results from the parameter representation

$${\vec{r}}_{f} ( a , b ) = {\vec{r}}_{e} ( a , b ) = \frac{s}{2} {\vec{n}}_{e} ( a , b ) \qquad ( 12 )$$

Further spatial equidistant calculation rules may also be possible according to the invention.

The method of circular equidistants also assumes a precisely scraping screw profile in the plane. Starting from the precisely scraping screw profile in the x-y-plane, a perpendicular is cut at each point, wherein the direction of the perpendicular is selected so that it points towards the inside of the screw profile. The point, which is shifted by s/2 along this perpendicular into the inside of the screw profile, then belongs to the technically executed screw profile. If a portion of a precisely scraping screw profile is a circular arc with radius rᵢ, the corresponding section of the associated technically executed screw profile is a circular arc with the same center and radius rᵢ—s/2.

This is a circular equidistant calculation rule in the context of the present invention.

Further circular equidistant calculation rules may also be possible according to the invention.

With the methods of longitudinal section equidistants, spatial equidistants and circular equidistants, different surface curves of the technically executed screw profile to be produced may overlap, so that several points on the screw profile curve can be selected for a certain angle starting from the center of rotation P of the screw profile. The point that is closer to the center of rotation P is then used to manufacture the screw profile for the technically feasible screw profile.

Various shapes can be used to represent the technically executed screw profile to be produced, for example tables of coordinates. A preferred method is to specify the distance to the axis of rotation r(γ) as a 2 π or 360° periodic function of the angle γ to the x-axis, using the representation

$$( \begin{matrix}x \\ y\end{matrix} ) = ( \begin{matrix}r ( γ ) cos γ \\ r ( γ ) sin γ\end{matrix} ) \qquad ( 13 )$$

With all of the methods mentioned, there is also a small increase in the flank angles and a reduction in the crest angle or crest angles compared to the flank angles and the crest angle or crest angles of the precisely scraping screw profile. The application of the spatial equidistant method always results in smaller crest angles than the application of the longitudinal section equidistant method, and the circular equidistant method always results in smaller crest angles than the application of the circular equidistant method. For a larger gradient, the crest angle for the spatial and longitudinal section equidistant becomes larger, for a gradient towards infinity, the spatial and longitudinal section equidistant goes towards the circular equidistant, i.e. for a gradient towards infinity, the spatial and longitudinal section equidistant calculation rule provides the same crest angle as the circular equidistant calculation rule.

All methods for determining a technically executed geometry of screw profiles based on a precisely scraping screw profile—i.e. the clearance strategies—reduce the size of the screw element compared to a screw element with this precisely scraping screw profile in order to obtain the actual technically executable geometry of a screw element: a distance is created between the precisely scraping screw profile and the technically executed, practically scraping, screw profile. A clearance strategy is used to determine the screw element-to-screw element clearance s, i.e. the distance between the screw profiles of a pair of screw elements that lie opposite each other on two directly neighboring screw shafts. Here, this screw element-to-screw element clearance s does not have to be constant between these two screw elements, but it is preferably constant.

To produce a constant clearance between the screw element and the screw element s when the screw elements are scraped against each other, the spatial equidistant is preferred as explained above.

Large screw element-to-screw element clearances s reduce the energy input into an extrudate because this reduces the shear. However, oversized screw element-to-screw element clearances s and screw element-to-housing clearances δ are also a disadvantage in technically executed extruders. They lead to reduced scraping of screw elements, which are positioned opposite each other in pairs on directly adjacent screw shafts, and to a deterioration in the exchange of extrudate on the screw elements or the housing bore, thereby increasing the risk of damaged extrudate being produced due to long dwell times and entering the extrudate stream, which can lead to specks, gels or discoloration, which in turn impairs the quality of the desired end product. Excessively large screw element-to-screw element clearances s and screw element-to-housing clearances δ also lead to reduced degassing and a reduced mixing effect due to reduced extrudate exchange on the screw surfaces or on the housing bore inner wall.

In addition, the influence that can be exerted on the sum of the crest angles via screw element-to-screw element clearances s is limited.

In addition to the screw profile, other variables play a role in the geometry of a screw element, as is known to a person skilled in the art. These are listed, for example, in [1] on page 115.

As shown above, the prior art does not present a solution to the problem of how to achieve good degassing of the extrudate in an extruder, which requires a high shear, and at the same time avoid damage to the extrudate due to excessive energy input, which is a consequence of the high shear, while additionally increasing the extrudate exchange at the housing bore inner wall of an extruder, because otherwise the degassing of the extrudate is only low, and achieving a good mixing effect and dispersion.

A good mixing effect is required for good degassing, as degassing takes place primarily from the surface of the extrudate and fresh, not yet degassed extrudate must be transported there to enable further degassing. Furthermore, the degassed extrudate should also be as homogeneous as possible, which requires a uniform energy input and the avoidance of localized overheating.

As is known to a person skilled in the art and explained, for example, in [1] on pages 475 to 478, there is a particularly high shear stress in the region of the crests near the housing bore inner wall, which is conducive to dispersion. This is particularly important when dispersing solid agglomerates that are used as fillers or reinforcing materials, which is another basic operation on extruders. Frequent replacement of the sheared material is therefore also conducive to the dispersing effect, as is known to a person skilled in the art. However, [1] on page 478 only refers to a reduced throughput as a method for better dispersion, which is not favored for reasons of economy.

### SUMMARY

It is therefore the object of the present invention to ensure good degassing of an extrudate in an extruder and at the same time—through low energy input—to avoid damage to the extrudate. A further object of the present invention is to additionally ensure good dispersion.

In particular, it is the object of the present invention to provide a pair of screw elements which ensure good degassing of an extrudate in an extruder and at the same time prevent damage to the extrudate. The pair of screw elements should also achieve good dispersion and a good mixing effect. Damage to the extrudate should preferably be avoided by the fact that the pair of screw elements ensures a reduced energy input into the extrudate without impairing the degassing of the extrudate.

Surprisingly, the object is achieved by a multishaft screw machine having the features of the main claim.

The object is further achieved in particular by a method according to claim 12.

In the context of this invention, the following shall apply:

A screw profile is a closed convex curve. A screw profile is made up of several different curves, which—depending on their geometric properties—are referred to as a “crest”, a “flank” or a “groove”.

The radius of curvature of the screw profile is, at every point, less than or equal to the center distance and greater than or equal to zero. A radius of curvature of zero is equivalent to a kink in the screw profile.

A kink is a point on a screw profile where, starting from a parameter representation

$$\vec{k} ( l ) = ( \begin{matrix}x ( l ) \\ y ( l )\end{matrix} ) \qquad ( 14 )$$

with the arc length l as parameter for a parameter value lₖ, the left-hand and right-hand limits for the values of the functions x(l) and y(l) coincide (this is identical to the property that the curve is closed at this point), i.e.

$${lim}_{l \to {l}_{k} , l < {l}_{k}} ( \begin{matrix}x ( l ) \\ y ( l )\end{matrix} ) = {lim}_{l \to {l}_{k} , l > {l}_{k}} ( \begin{matrix}x ( l ) \\ y ( l )\end{matrix} ) \qquad ( 15 )$$

and the direction vectors of the derivatives of the curve according to the arc length l do not point in the same direction, i.e. their cross product does not vanish:

$${lim}_{l \to {l}_{k} , l < {l}_{k}} ( \begin{matrix}\frac{d x ( l )}{d l} \\ \frac{d y ( l )}{d l}\end{matrix} ) \times {lim}_{l \to {l}_{k} , l > {l}_{k}} ( \begin{matrix}\frac{d x ( l )}{d l} \\ \frac{d y ( l )}{d l}\end{matrix} ) \neq 0 \qquad ( 16 )$$

In the event that two circular arcs as part of a screw profile do not merge into one another tangentially, the kink is located at the intersection of the two circular arcs. It is possible to treat a kink as a circular arc with the center point equal to the intersection of the two circular arcs and with radius zero; this is done in the examples.

A curve is an unbroken line with a length greater than zero but no width, wherein a curve has a first endpoint and a second endpoint that are not one and the same point; that is to say, the first endpoint does not coincide with the second endpoint.

A curve can be composed of several, finitely many curve sections, wherein a first curve section has a common point of contact with a second curve section that is directly neighboring the first curve section.

However, a curve can also consist of exactly one curve section.

A curve may only have a finite number of kinks, which by definition can only lie at the common point of contact of two directly neighboring curve sections of a curve. A kink can also be located at the common point of contact between two directly neighboring curves.

A curve section is a section of a curve, wherein the curve section has a first endpoint and a second endpoint that are not one and the same point; that is to say, the first endpoint does not coincide with the second endpoint.

A curve section is preferably selected from the group comprising the following members: circular arc, elliptical arc, parabolic arc, or a spline or a portion of a spline, result of applying the longitudinal section equidistant calculation rule according to [1], pages 117 to 121 to circular arcs, elliptical arcs or parabolic arcs, or to a spline or a portion of a spline, result of the application of the spatial equidistant calculation rule to circular arcs, elliptical arcs or parabolic arcs, or to a spline or to a portion of a spline, or result of the application of the circular equidistant calculation rule to circular arcs, elliptical arcs, parabolic arcs, or to a spline or to a portion of a spline.

It is also true for a curve section \vec{k} that it is a line that can be represented in a parameter representation of its arc length l

$$\vec{k} ( l ) = ( \begin{matrix}{x}_{k , l} ( l ) \\ {y}_{k , l} ( l )\end{matrix} ) \qquad ( 17 )$$

and where x_{k,l}(l) and y_{k,l}(l) are analytical functions and x and y are the coordinates of the line in the plane and can therefore be represented by infinite power series, are continuous, can be differentiated any number of times and are therefore kink-free.

A section is either a curve section or a kink.

A closed, convex curve is an uninterrupted line with a non-zero length, but no width, composed of one or more curves, which in turn are composed of one or more curve sections. It does not have a marked start and end point. Starting from any point on the curve, it is possible to determine the length of the curve by adding up the length of the curve sections once around the curve. Every tangent to a closed, convex curve lies outside the area enclosed by the curve.

As all curve sections of a screw profile are located in one plane, a closed curve, which is a screw profile, divides the area of this plane into an area inside the closed curve and an area outside the closed curve.

A circular arc is a curve section in which all points of the circular arc have the same distance, called the radius, from a common center point. An arc has a starting point and an end point that are not one and the same point.

A circular arc is only considered to be a circular arc if all points of this circular arc have the same center and the same radius and the points of this circular arc form an uninterrupted curve section; in other words, two directly adjacent circular arcs that have a common point of contact are only considered to be two circular arcs if they have a different center or a different radius. In accordance with the invention, only circular arcs are used that have a smaller center angle in radians than π.

A circular arc i is characterized by the coordinates of its center xmᵢ and ymᵢ, by its radius rᵢ, by its start angle β_{a,i} and its center angle αᵢ, wherein the valid values for the angle β in formula (10) are between β_{a,i} and

$${β}_{e , i} = {β}_{a , i} + {α}_{i} \qquad ( 18 )$$

The center of rotation P of a screw profile is the intersection of the axis of rotation X of a screw element with the cross-sectional plane at right angles to this axis of rotation. The center of rotation P of the screw profile, hereinafter also referred to as the pivot point P or pivot point, also coincides with the center of the bore M of the housing bore in which the respective screw element is located or for which the respective screw element is designed.

In relation to a screw profile, a pivot point P is the point around which a screw profile rotates as a cross-sectional image of a screw element.

A crest is a curve of a screw profile in which all points of this curve have a greater distance from the pivot point P than the two curve sections immediately neighboring the crest, except for the points of contact with the two curve sections immediately neighboring the crest. According to the invention, the curve forming a crest is precisely a curve section which is precisely a circular arc with the pivot point P of the screw profile as the center.

According to the invention, preferably all crests of a screw profile are each formed by exactly one circular arc, each of which has the pivot point P of the screw profile as its center.

The crest radius is the distance of the respective crest from the pivot point P of a screw profile.

A groove is a curve of a screw profile in which all points of this curve have a smaller distance from the pivot point P than the two curve sections immediately neighboring the groove, except for the points of contact with the two curve sections immediately neighboring the groove.

According to the invention, the curve forming a groove is precisely a curve section which is precisely a circular arc with the pivot point P of the screw profile as the center.

According to the invention, preferably all grooves of a screw profile are each formed by exactly one circular arc, each of which has the pivot point P of the screw profile as its center.

A flank is a curve of a screw profile convex to the center of rotation P between a crest and a groove, wherein this flank has a common point of contact with the crest and with the groove.

A flank can be a single curve section or can be composed of several curve sections. The radius of curvature of a flank is less than or equal to the center distance A at every point, preferably less than the center distance A.

According to the invention, the mathematical expressions on which a curve portion of a slope is based are preferably selected from the group of mathematical expressions comprising the following members: circular arc, result of the application of the longitudinal section equidistant calculation rule according to [1], pages 117 to 121 to a circular arc with a radius of curvature smaller than center distance A or equal to center distance A of a precisely scraping screw profile composed only of circular arcs, result of the application of the spatial equidistant calculation rule to a circular arc with a radius of curvature smaller than center distance A or equal to center distance A of a precisely scraping screw profile composed only of circular arcs, and result of the application of the circular equidistant calculation rule to a circular arc with a radius of curvature smaller than center distance A or equal to center distance A of a precisely scraping screw profile composed only of circular arcs.

Components of the pair of screw elements according to the invention or of the associated screw profiles can be provided with index characters such as n, m, or i, or also with natural numbers, in order to be able to distinguish these components from one another if these components can occur more than once.

Furthermore, the following shall apply within the context of the present invention:

TABLE 1
Parameters for representing a screw profile

| | | Calculation (if | |
|---|---|---|---|
| Variable | Symbol | applicable) | Calculation from given variables |
| center distance | A | specified by | |
| | | existing | |
| | | extruder | |
| housing bore inner | D | specified by | |
| diameter | | existing | |
| | | extruder | |
| pitch | T | selected | |
| screw element-to- | δ | selected | |
| housing wall | | | |
| clearance | | | |
| screw element-to- | s | selected | |
| screw element | | | |
| clearance | | | |
| screw outer diameter, | DA | DA = D − 2δ | DA = D − 2δ |
| technical design | | | |
| screw outer radius, | RA | RA = DA/2 | RA = D/2 − δ |
| technical design | | | |
| screw core diameter, | DK | DK = 2A − DA − 2s | DK = 2A − D +2δ − 2s |
| technical design | | | |
| screw core radius, | RK | RK = DK/2 | RK = A − D/2 + δ − s |
| technical design | | | |
| screw outer diameter, | DE | DE = DA + s | DE = D − 2δ + s |
| precisely scraping | | | |
| screw outer radius, | RE | RE = DE/2 | RE = D/2 − δ + s/2 |
| precisely scraping | | | |
| screw core diameter, | DI | DI = 2A − DE | DI = 2A − D + 2δ − s |
| precisely scraping | | | |
| screw inner radius, | RI | RI = DI/2 | RI = A − D/2 + δ − s/2 |
| precisely scraping | | | |
| additional gap, i.e. distance between screw element and | SP | selected so that $SP < \frac{GT}{2}$ | |
| housing wall, which | | | |
| extends beyond the | | | |
| screw element-to- | | | |
| housing wall | | | |
| clearance δ | | | |
| flight depth | GT | GT = RA − RK | GT = D − 2δ − A + s |
| sum of the crest | BKW | | |
| angles of a pair of | | | |
| screw elements | | | |
| located opposite each | | | |
| other on directly | | | |
| neighboring shafts | | | |
| limit value of the sum | BKGW | | formula (2) |
| of the crest angles of | | | |
| a pair of screw | | | |
| elements located | | | |
| opposite each other | | | |
| on directly | | | |
| neighboring shafts | | | |
| error function: | erf [symbol] | Gaussian error function | $erf x = \frac{2}{π} {\int }_{0}^{x} {e}^{- {t}^{2}} d t$ |
| parameter display of | \vec{r}ₑ(a, b) | | |
| the precisely scraping | | | |
| profile | | | |
| normal vector | \vec{n}ₑ(a, b) | calculated from the parameter display of the exactly | ${\vec{n}}_{e} ( a , b ) = \pm \frac{\frac{\partial {\vec{r}}_{e}}{\partial a} \times \frac{\partial {\vec{r}}_{e}}{\partial b}}{\vert \frac{\partial {\vec{r}}_{e}}{\partial a} \times \frac{\partial {\vec{r}}_{e}}{\partial b} \vert}$ |
| | | scraping | |
| | | profile | |
| distance of the profile | r | calculated | |
| line to the axis of | | from the | |
| rotation of a screw | | parameter | |
| profile | | display of the | |
| | | exactly | |
| | | scraping | |
| | | profile | |
| angle to the x-axis of | γ | free parameter | |
| a screw profile in a | | between 0 and | |
| Cartesian coordinate | | 2 π (Pi) | |
| system, in which the | | | |
| coordinate along the | | | |
| axis of rotation of the | | | |
| extruder is designated | | | |
| as z and x and y are | | | |
| the coordinates in the | | | |
| plane perpendicular | | | |
| to the axis of rotation | | | |
| that intersects the | | | |
| plane at x = 0, y = 0 | | | |
| and z = 0 | | | |
| distance of the profile | r(γ) | calculated | |
| line to the axis of | | from the | |
| rotation of a screw | | parameter | |
| profile at a specific | | display of the | |
| angle γ | | exactly | |
| | | scraping | |
| | | profile | |
| outer surface of a screw element | \vec{r}_{F}(a, b) | calculated from the | ${\vec{r}}_{f} ( a , b ) = {\vec{r}}_{e} ( a , b ) - \frac{s}{2} {\vec{n}}_{e} ( a , b )$ |
| | | parameter | |
| | | display of the | |
| | | exactly | |
| | | scraping | |
| | | profile | |
| circular arc radius i | rᵢ | | |
| y-coordinate of the | ymᵢ + | | |
| center of a circular | rᵢ sin β | | |
| arc i of a precisely | | | |
| scraping contour | | | |
| x-coordinate of the | xmᵢ + | | |
| center of a circular | rᵢ cosβ | | |
| arc i of a precisely | | | |
| scraping contour | | | |
| precisely scraping | \vec{r}_{e,i}(β,z) | | |
| outer surface, | | | |
| belonging to the | | | |
| circular arc i | | | |
| initial sum of the crest angles of a single screw element | SKW0 | | $SKW 0 = π - \frac{1}{2} ( arccos ( \frac{{A}^{2} - 2 R {A}^{2}}{2 R {A}^{2}} ) +$ |
| with precisely scraping screw profile from the prior art / | | | $arccos ( \frac{{A}^{2} - 2 {RA}^{2} + 2 RASP - S {P}^{2}}{2 RA ( R A - S P )} ) +$ |
| according to [5] for a pair of screw elements located | | | $arccos ( \frac{{A}^{2} - 2 {( R A - S P )}^{2}}{2 {( R A - S P )}^{2}} ) +$ |
| opposite each other on directly neighboring shafts | | | $arccos ( \frac{{A}^{2} - 2 {RA}^{2} + 2 RASP - S {P}^{2}}{2 RA ( R A - S P )} ) )$ |

Insofar as it is explained in the context of the present description that a value is “selected” for a variable, as is the case, for example, with the pitch T, the screw element-to-housing wall clearance δ, the screw element-to-screw element clearance s, or the additional gap SP, this does not mean that any value can be assigned to this variable if screw profiles are to be obtained for a pair of screw elements that are to be usable as intended. A person skilled in the art of designing screw elements for extruders can estimate or use CFD simulations to determine which values should be sensibly assigned to these variables for a given extruder, depending, for example, on the viscosity of the extrudate at the processing temperature, the desired filling level of the extruder, the desired energy input into the extrudate or the speed of the shafts. In particular, if such a value was obtained by estimation, it is usually necessary to confirm it by simulations or to determine it more precisely; this is usually done iteratively.

By selecting the additional gap SP, the mass transfer at the inner wall of the housing and the mixing effect can be adjusted. The maximum shear can be set by appropriately selecting 8 and the crest angle and thus the length over which the maximum shear between the crest and housing should act can be set using f.

(1) The objects are in particular achieved in a first embodiment of the invention by:
a pair of screw elements, suitable for a multishaft screw machine
with m screw shafts SW₁ to SWₘ rotating in the same direction and at the same speed, the respective neighboring axes of rotation X₁ to Xₘ of which have a center distance A in a cross-section at right angles to the axes of rotation
   and
with m interpenetrating circular housing bores which each have an identical housing bore inner diameter D and of which the bore centers M₁ to Mₘ have a distance equal to the center distance A, and of which the bore centers M₁ to Mₘ coincide with the respective associated axes of rotation X₁ to Xₘ of the screw shafts SW₁ to SWₘ and coincide with the centers of rotation P₁ to Pₘ of the screw elements,
wherein the two screw elements of the pair of screw elements lie opposite each other on directly neighboring screw shafts,
wherein the two screw elements of the pair of screw elements scrape each other with a screw element-to-screw element clearance s,
wherein both screw elements have an asymmetrical screw profile,
wherein both screw elements each have exactly two crests,
wherein for each of the two screw elements, its two crests have different distances to the respective center of rotation P of the screw profile,
wherein in each case one crest has a distance D/2 reduced by a screw element-to-housing wall clearance δ and further reduced by an additional gap SP to the respective center of rotation P and the other crest has a distance D/2 reduced by a screw element-to-housing wall clearance δ, but not reduced by an additional gap SP, to the respective center of rotation P,
   wherein the screw element-to-housing wall clearance δ is the same for both screw elements and the additional gap SP is the same for both screw elements,
wherein the sum of the crest angles BKW of the crests of both screw elements in radians is greater than 0
and
for the factor f with

$$f = BKW / BKGW \qquad ( 19 )$$

it is true that the factor f is greater than 0 and less than or equal to 0.95,
wherein BKW is the sum of the crest angles in radians of both screw elements and BKGW is determined by:

$$BKGW = 2 ( π - \frac{1}{2} ( arccos ( \frac{{A}^{2} - 2 {RE}^{2}}{2 {RE}^{2}} ) + arccos ( \frac{{A}^{2} - 2 {RE}^{2} + 2 RE SP - {SP}^{2}}{2 RE ( RE - SP )} ) + arccos ( \frac{{A}^{2} - 2 {( RE - SP )}^{2}}{2 {( RE - SP )}^{2}} ) + arccos ( \frac{{A}^{2} - 2 {RE}^{2} + 2 RE SP - {SP}^{2}}{2 RE ( RE - SP )} ) ) - \frac{s}{T} ( 26.22113 - 16.036523 \frac{A}{D} - 30.9465 \frac{δ}{D} + 14.5763 \frac{s}{D} - 0.20071 \frac{T}{D} - 0.00475 \frac{SP}{GT} + 4.89626 erf ( - 0.855 \frac{T}{D} ) ) ) . \qquad ( 20 )$$

Equal screw element-to-housing wall clearances δ or equal additional gaps SP have the advantage of an even energy input.

### BRIEF DESCRIPTION OF DRAWINGS

FIG. 1 shows a screw profile of a left-hand screw according to the invention.

FIG. 2 shows screw profiles of a pair of screw elements not according to the invention.

FIG. 3 shows a plan view of a screw element pair not according to the invention.

FIG. 4 shows screw profiles of a screw element pair according to the invention.

FIG. 5 shows a plan view of a screw element pair according to the invention.

FIG. 6 shows screw profiles of the screw element pair according to the invention.

FIG. 7 shows a plan view of a screw element pair according to the invention.

FIG. 8 shows screw profiles of a screw element pair according to the invention.

FIG. 9 shows a plan view of a screw element pair according to the invention.

### DETAILED DESCRIPTION

(2) Preferably f is greater than or equal to 0.1 and less than or equal to 0.8 and particularly preferably f is greater than or equal to 0.2 and less than or equal to 0.6.

This preferred embodiment of the invention is a second embodiment according to the first embodiment presented above.
(3) Preferably, the ratio of the screw element-to-screw element clearance s between the two screw elements of a pair of screw elements to the housing bore inner diameter D is from 0.002 to 0.05, preferably from 0.003 to 0.03 and particularly preferably from 0.005 to 0.02.

This preferred embodiment of the invention is a third embodiment according to the first or second embodiment presented above.
(4) It is further preferred that the screw element-to-housing wall clearance δ in relation to the housing bore inner diameter D is 0.002 to 0.05, preferably from 0.003 to 0.03 and particularly preferably from 0.005 to 0.02. This particularly preferred embodiment of the method of the invention is a fourth embodiment in accordance with one of the embodiments presented above.
(5) It is further preferred here that the additional gap SP in relation to the flight depth GT of the respective screw element is 0.015 to 0.4, preferably from 0.02 to 0.3 and particularly preferably from 0.025 to 0.25.

This particularly preferred embodiment of the invention is a fifth embodiment according to one of the embodiments presented above.
(6) Further preferably, the crest angles of the crests of the pair of screw elements which have the screw element-to-housing wall clearance δ but not the additional gap SP to the housing bore inner wall are the same.

This further preferred embodiment of the invention represents a sixth embodiment according to one of the embodiments presented above.
(7) Also further preferably, the crest angles of the crests of the pair of screw elements having the clearance screw element housing wall δ and the additional gap SP to the housing bore inner wall are the same.

This further preferred embodiment of the invention represents a seventh embodiment according to one of the embodiments presented above.
(8) It is additionally preferred that, for both screw elements of the pair of screw elements, it is true that the crest angles of the crests of the screw elements of the pair of screw elements which have the screw element-to-housing wall clearance δ and the additional gap SP are greater than the crest angles of the crests of the screw elements of the pair of screw elements that have the screw element-to-housing wall clearance δ, but not the additional gap SP.

This additionally preferred embodiment of the invention represents an eighth embodiment according to one of the embodiments shown above.
(9) Very particularly preferably, the screw profiles of the pair of screw elements are not congruent, wherein the screw profiles of the two screw elements can be merged into one another by mirroring the axes and rotating them.

This very particularly preferred embodiment of the invention is a ninth embodiment in accordance with one of the first to eighth embodiments presented above.

The fact that the screw profiles of the two screw elements can be merged into one another by mirroring the axes and rotating them means that the energy input into each of the two screw elements of a pair of screw elements is the same. This has proven to be advantageous because it prevents localized overheating of the extrudate when the pair of screw elements according to the invention is used as intended.
(10) It is also preferred that each of the two screw profiles of the pair of screw elements has exactly two (2) grooves and exactly four (4) flanks.

This very particularly preferred embodiment of the invention is a tenth embodiment in accordance with one of the first embodiment presented above.
(11) It is also preferred that the two screw profiles of the pair of screw elements has exactly four (4) grooves and exactly eight (8) flanks.

This particularly preferred embodiment of the invention represents an eleventh embodiment according to one of the tenth embodiment presented above.

The pair of screw elements according to the invention can be formed as a pair of conveying elements or as a pair of kneading disks; preferably according to the invention, it is embodied as a pair of conveying elements.

The present invention also relates to a multishaft screw machine comprising the pair of screw elements according to the invention.

The present invention further relates to a method for producing or processing an extrudate using the pair of screw elements according to the invention in a multishaft screw machine. The extrudate is preferably a plastic or viscoelastic mass, particularly preferably a polymer melt, especially a melt of a thermoplastic or an elastomer, in particular a melt of a polycarbonate or a polyester carbonate or a thermoplastic polyurethane or a rubber. The method preferably comprises the steps of
(1) providing a multishaft screw machine comprising a pair of screw elements according to the invention;
(2) producing or processing an extrudate.

The present invention also relates to a method for producing the screw profiles of the screw elements of the pair of screw elements according to the invention starting from a precisely scraping screw profile according to the prior art.

The screw profiles of a pair of screw elements according to the invention can be produced, for example, as explained below, using, as the starting point, an existing extruder with values for the center distance A and the housing bore inner diameter D, wherein each of the two screw elements has exactly two crests and the two screw elements of a pair of screw elements are designated as the left and right screw element in formula symbols by a subscript l and r, respectively.

In order to calculate the values of the screw elements used to generate the screw profiles of a pair of screw elements according to the invention, both the values of variables of a pair of screw elements which precisely scrape each other and the values of variables of a pair of screw elements which practically scrape each other are used, wherein the values of the variables of a pair of screw elements which practically scrape each other depend on the values of the variables of a pair of screw elements which precisely scrape each other and can be calculated from them according to table 1.
(I) In a first step the value for the screw element-to-screw element clearance s and the value for the screw element-to-housing wall clearance δ, which are to apply to the executed screw element, are selected.
(II) In a second step, the value for the outer radius RE of a precisely scraping screw profile is determined according to the equation:

$$RE = DE / 2 \qquad ( 21 )$$

with

$$DE = D - 2 δ + s \qquad ( 22 )$$

(III) In a third step, the value for the inner radius RI of a precisely scraping screw profile is determined according to the equation:

$$RI = \frac{DI}{2} = A - D / 2 + δ - s / 2 \qquad ( 23 )$$

(IV) In a fourth step, the outer radius RA of a technically executable/correctly usable screw element is determined according to the equation:

$$RA = D / 2 - δ \qquad ( 24 )$$

(V) In a fifth step, the inner radius RK of a technically executable/correctly usable screw element is determined according to the equation:

$$RK = A - D / 2 + δ - s \qquad ( 25 )$$

(VI) In a sixth step, the flight depth of a technically executable/correctly usable screw element is calculated using the equation

$$GT = RA - RK \qquad ( 26 )$$

(VII) In a seventh step, a value is selected for the additional gap SP of a technically executable/correctly usable screw element, wherein SP<GT/2 is always true.
   Steps (II) to (V) can be performed in any sequence.
(VIII) In an eighth step, the initial sum of the crest angles SKW0 of the respective screw element is determined for each of the two screw elements of a pair of precisely scraping screw elements according to equation (4) or (27):

$$SKW 0 = π - \frac{1}{2} ( arccos ( \frac{{A}^{2} - 2 {RA}^{2}}{2 {RA}^{2}} ) + arccos ( \frac{{A}^{2} - 2 {RA}^{2} + 2 RA SP - {SP}^{2}}{2 RA ( RA - SP )} ) + arccos ( \frac{{A}^{2} - 2 {( RA - SP )}^{2}}{2 {( RA - SP )}^{2}} ) + arccos ( \frac{{A}^{2} - 2 {RA}^{2} + 2 RA SP - {SP}^{2}}{2 RA ( RA - SP )} ) ) \qquad ( 27 )$$

(IX) In a ninth step, the sum of the crest angles of a pair of precisely scraping screw elements BSKW0 is calculated according to

$$BSKW 0 = 2 g SKW 0 \qquad ( 28 )$$

wherein the factor g is selected, wherein g is greater than 0.1 and less than 0.95, preferably greater than 0.15 and less than 0.8 and particularly preferably greater than 0.2 and less than 0.6.
(X) In a tenth step, for a pair of screw elements precisely scraping each other, the crest angle KW0_{l,δ} of the precisely scraping profile of the left-hand screw element and the crest angle KW0_{r,δ} of the right-hand screw element are determined for that crest of the respective screw element which in each case has the screw element-to-housing wall clearance δ to the housing bore inner wall, labelled with a subscript δ in formula symbols, but not the additional gap SP, specifically such that the following applies for the sum of the crest angles of these crests:

$$KW {0}_{l , δ} + KW {0}_{r , δ} < BSKW 0 \qquad ( 29 )$$

preferably

$$KW {0}_{l , δ} + KW {0}_{r , δ} < \frac{BSKW 0}{2} \qquad ( 30 )$$

and particularly preferably

$$KW {0}_{l , δ} = KW {0}_{r , δ} = KW {0}_{δ} < \frac{BSKW 0}{4} \qquad ( 31 )$$

wherein all crest angles are greater than 0.
(XI) In an eleventh step, for a pair of screw elements precisely scraping each other, the crest angle KW0_{l,δ+SP} of the screw profile of the left-hand screw element and the crest angle KW0_{r,δ+SP} of the right-hand screw element are determined for the crest of the respective screw element, which in each case has the screw element-to-housing wall clearance δ and the gap SP, i.e. δ+SP, labelled with a subscript δ+SP in formula symbols, specifically such that the following applies for the sum of the crest angles of these crests:

$$KW {0}_{l , δ + SP} + KW {0}_{r , δ + SP} = BSKW 0 - ( KW {0}_{l , δ} + KW {0}_{r , δ} ) \qquad ( 32 )$$

and preferably

$$KW {0}_{l , δ + SP} + KW {0}_{r , δ + SP} = 2 KW {0}_{δ + SP} = BSKW 0 - ( KW {0}_{l , δ} + KW {0}_{r , δ} ) \qquad ( 33 )$$

(XII) In a twelfth step, the screw profile of the first screw element, selected here as the left-hand screw element—the right-hand screw element could also be selected—is constructed for a pair of precisely scraping screw elements and consists of the curves mentioned below. These curves follow one another directly in a direction of rotation as specified below, wherein the direction of rotation can be mathematically positive or negative, and the curves merge into one another at their respective end points. This screw profile for the first screw element represents the generating screw profile.
   A circular arc with radius RE, with the angle KW0_{l,δ} and with the center of rotation P of the screw profile as the center, wherein this circular arc is the first crest
   A first flank [flank 1];
   A circular arc with radius RI, with the angle KW0_{r,δ} and with the center of rotation P of the screw profile as the center, wherein this circular arc is the first groove;
   A second flank [flank 2];
   A circular arc with radius RE−SP, angle KW0_{l,δ+SP} and center of the center of rotation P of the screw profile, which is the second crest;
   A third flank [flank 3];
   A circular arc with radius RI+SP, angle KW0_{r,δ+SP} and center of the center of rotation P of the screw profile, wherein this circular arc is the second groove;
   A fourth flank [flank 4], which closes the profile between the second groove and the first crest.
(XIII) In a thirteenth step, the screw profile of the second screw element, selected here as the right-hand screw element, is constructed for a pair of screw elements precisely scraping each other. For this purpose, the pivot point of the left-hand screw element is set to the coordinates x=0 and y=0 and the pivot point of the right-hand screw element is set to the coordinates x=A and y=0. The screw profile of the left-hand screw element is broken down geometrically into its curve sections and—if present—kinks i=1 . . . n. The precisely scraping screw profile of the right-hand screw element is then built up from curve sections corresponding to the screw profile of the left-hand screw element and—if available—kinks, called i′=1 . . . n.

For a curve section i, in a parameter representation

$${\vec{k}}_{i} ( p ) = ( \begin{matrix}{x}_{i} ( p ) \\ {y}_{i} ( p )\end{matrix} ) \qquad ( 34 )$$

with p_{a,i}≤p≤p_{e,i}, in which the derivative of the analytical functions xᵢ(p) and yᵢ(p) does not become zero for the same value and in which it is assumed, without limiting generality, that \vec{k}ᵢ(p) winds around the pivot point in a mathematically positive sense with increasing p, a normalized normal vector

$${\vec{n}}_{i} ( p ) = \pm ( \begin{matrix}\frac{{dy}_{i} ( p )}{dp} \\ - \frac{{dx}_{i} ( p )}{dp}\end{matrix} ) \cdot \frac{1}{\sqrt{{( \frac{{dy}_{i} ( p )}{dp} )}^{2} + {( \frac{{dx}_{i} ( p )}{dp} )}^{2}}} \qquad ( 35 )$$

is formed, wherein the sign is selected so that the normal vector points out of the profile, away from the pivot point.

Each curve section is assigned a start angle β_{a,i} and an end angle β_{e,i}. The start angle satisfies in p=pₐ the condition

$$( \begin{matrix}cos {β}_{a , i} \\ sin {β}_{a , i}\end{matrix} ) = {\vec{n}}_{i} ( {p}_{a} ) \qquad ( 36 )$$

and the end angle from the components of the normal vector with p=pₑ to give

$$( \begin{matrix}cos {β}_{e , i} \\ sin {β}_{e , i}\end{matrix} ) = {\vec{n}}_{i} ( {p}_{e} ) \qquad ( 37 )$$

wherein β_{e,i}>β_{a,i} and β_{e,i}<β_{a,i}+π.

The curve section i on the left-hand screw then corresponds to a curve section i′ on the right-hand screw with the coordinate representation

$${\vec{k}}_{i} ( p ) = ( \begin{matrix}{x}_{i} ( p ) \\ {y}_{i} ( p )\end{matrix} ) - A {\vec{n}}_{i} + A ( \begin{matrix}1 \\ 0\end{matrix} ) \qquad ( 38 )$$

In a preferred embodiment the curve section i represents a circular arc with the parameter representation

$${\vec{k}}_{i} ( β ) = ( \begin{matrix}{xm}_{i} + {r}_{i} cos β \\ {ym}_{i} + {r}_{i} sin β\end{matrix} ) \qquad ( 39 )$$

with β_{a,i}≤β≤β_{e,i}, then the normalized normal vector

$${\vec{n}}_{i} = ( \begin{matrix}sin β \\ cos β\end{matrix} ) \qquad ( 40 )$$

and the representation of the corresponding circular arc is

$${\vec{k}}_{{i}^{′}} ( β ) = ( \begin{matrix}{xm}_{i} + A + ( {r}_{i} - A ) cos β \\ {ym}_{i} + ( {r}_{i} - A ) sin β\end{matrix} ) = ( \begin{matrix}{xm}_{{i}^{′}} + {r}_{{i}^{′}} cos ( β + π ) \\ {ym}_{{i}^{′}} + {r}_{{i}^{′}} sin ( β + π )\end{matrix} ) \qquad ( 41 )$$

with r_{i′}=A−rᵢ, xm_{i′}=xmᵢ+A and ym_{i′}=ymᵢ and (as above) β_{a,i}≤β≤β_{e,i}.

If the curve section represents a circle with rᵢ=A, then r_{i′}=0, and the corresponding section is a kink.

If the section i represents a kink with the coordinates, this then corresponds to a circular arc of radius, the representation of which can be obtained from the above formula with r_{i′}=A.

In a preferred embodiment, the screw profile of the screw elements according to the invention is derived from a precisely scraping screw profile by using the center distance increase, the circular equidistant, the longitudinal equidistant or the spatial equidistant,

wherein the sum of the crest angles BKW of the crests of both screw elements in radians is greater than 0 and for the factor f with

$$f = BKW / BKGW \qquad ( 2 )$$

it is true that the factor f is greater than 0 and less than or equal to 0.95,
wherein BKW is the sum of the crest angles in radians of both screw elements and BKGW is determined by:

$$BKGW = 2 ( π - \frac{1}{2} ( arccos ( \frac{{A}^{2} - 2 {RE}^{2}}{2 {RE}^{2}} ) + arccos ( \frac{{A}^{2} - 2 {RE}^{2} + 2 RE SP - {SP}^{2}}{2 RE ( RE - SP )} ) + arccos ( \frac{{A}^{2} - 2 {( RE - SP )}^{2}}{2 {( RE - SP )}^{2}} ) + arccos ( \frac{{A}^{2} - 2 {RE}^{2} + 2 RE SP - {SP}^{2}}{2 RE ( RE - SP )} ) ) - \frac{s}{T} ( 26.22113 - 16.0 \; 3623 \frac{A}{D} - 30.9 \; 465 \frac{δ}{D} + 14.5 \; 763 \frac{s}{D} - 0.20071 \frac{T}{D} - 0.0 \; 0475 \frac{SP}{GT} + 4.8 \; 9626 erf ( - 0.855 \frac{T}{D} ) ) ) . \qquad ( 43 )$$

In a further preferred embodiment, the screw profile of the screw elements according to the invention is composed of curve sections selected from the group of mathematical expressions comprising the following members: circular arc, elliptical arc, parabolic arc, spline or portion of a spline, result of applying the longitudinal section equidistant calculation rule according to [1], pages 117 to 121 to circular arcs, elliptical arcs, parabolic arcs, or to a spline or to a portion of a spline, result of the application of the spatial equidistant calculation rule to circular arcs, elliptical arcs, parabolic arcs, or to a spline or to a portion of a spline, or result of the application of the circular equidistant calculation rule to circular arcs, elliptical arcs, parabolic arcs, or to a spline or to a portion of a spline.

In a further preferred embodiment, at least two pairs of screw elements according to the invention are arranged axially directly one behind the other in a multishaft screw machine. Such an arrangement is shown in principle, for example, in PCT/EP2021/078863, wherein PCT/EP2021/078863 describes in particular pairs of screw elements which precisely clean each other, whereas the present invention relates to practically scraping screw elements.

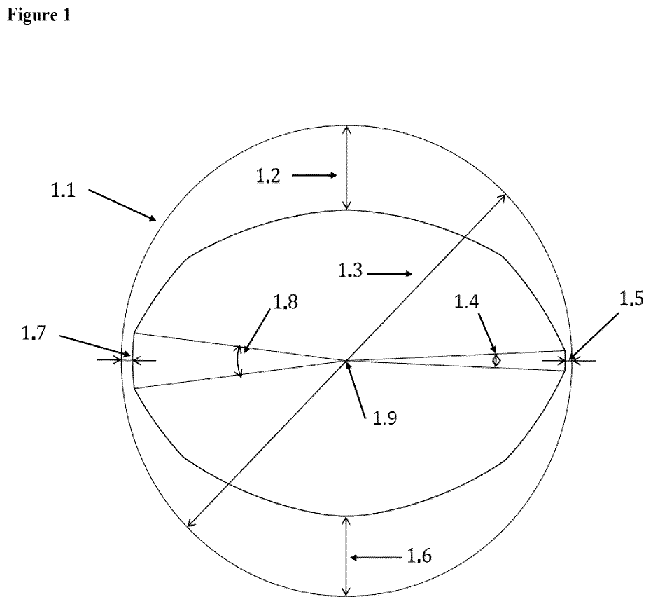

FIG. 1 shows the practically scraping screw profile of the left-hand screw element from example 2 to illustrate the geometric dimensions.

The invention is elucidated hereinbelow with reference to examples, without any intention that the invention be limited to these examples.

### Example 1 (Comparative Example—Noninventive)

Noninventive example 1 is a pair of two mutually practically scraping screw elements with

$$\frac{A}{D} = 0.825 , T / D = 1.2 , \frac{δ}{D} = 0.015 , \frac{s}{D} = 0.02 and \frac{SP}{D} = 0.01$$

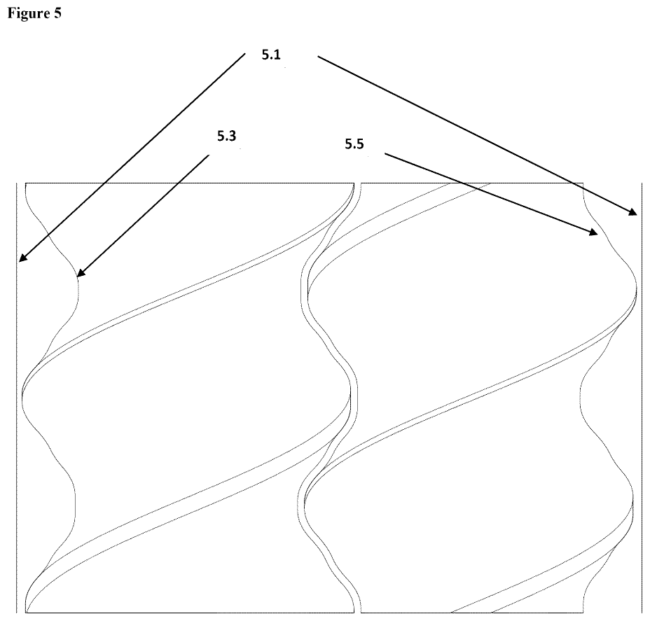

according to EP 0002131 A1, FIG. 5(A) and FIG. 5(B), wherein the spatial equidistant calculation rule is additionally applied to the screw profile according to EP 0002131 A1, FIG. 5(A) or FIG. 5(B). The screw profiles of the screw elements are asymmetrical, not congruent, but they can be merged into one another by mirroring the axes and rotating them.

The precisely scraping screw profile of the left screw element consists of the sections i=1 to 12, which are either circular arcs or kinks. The circular arcs, start angle, end angle, arc radius relative to the housing bore inner diameter D, x-coordinate of the center of the circular arc i relative to the pivot point P₁ of the left-hand screw profile relative to the housing bore inner diameter D and y-coordinate of the center of the circular arc i relative to the pivot point of the left-hand screw profile P₁ relative to the housing bore inner diameter D are given in table 2. The crests of the practically scraping screw profile are the circular arcs 1 and 7. Kinks can be recognized by the fact that the value is

$$\frac{{r}_{i}}{D} = 0 .$$

TABLE 2
Circular arcs of the precisely scraping profile of the left-hand screw profile
from example 1.

| i | αᵢ | β_{a,i} | β_{e,i} | $\frac{{r}_{i}}{D}$ | $\frac{{xm}_{i}}{D}$ | $\frac{{ym}_{i}}{D}$ |
|---|---|---|---|---|---|---|
| 1 | 0.39943 | −0.19971 | 0.19971 | 0.49500 | 0.00000 | 0.00000 |
| 2 | 0.58569 | 0.19971 | 0.78540 | 0.00000 | 0.48516 | 0.09820 |
| 3 | 0.58569 | 0.78540 | 1.37108 | 0.82500 | −0.09820 | −0.48516 |
| 4 | 0.39943 | 1.37108 | 1.77051 | 0.33000 | 0.00000 | 0.00000 |
| 5 | 0.56361 | 1.77051 | 2.33412 | 0.82500 | 0.09820 | −0.48516 |
| 6 | 0.57670 | 2.33412 | 2.91081 | 0.00000 | −0.47214 | 0.11094 |
| 7 | 0.46235 | 2.91081 | 3.37316 | 0.48500 | 0.00000 | 0.00000 |
| 8 | 0.55383 | 3.37316 | 3.92699 | 0.00000 | −0.47205 | −0.11131 |
| 9 | 0.55383 | 3.92699 | 4.48082 | 0.82500 | 0.11131 | 0.47205 |
| 10 | 0.46235 | 4.48082 | 4.94317 | 0.34000 | 0.00000 | 0.00000 |
| 11 | 0.57670 | 4.94317 | 5.51986 | 0.82500 | −0.11094 | 0.47214 |
| 12 | 0.56361 | 5.51986 | 6.08347 | 0.00000 | 0.48516 | −0.09820 |

The precisely scraping screw profile of the right-hand screw element consists of the sections i=1′ to 12′, which are either circular arcs or kinks. Table 3 shows the start angle, end angle, arc radius relative to the housing bore inner diameter D, x-coordinate of the center of the circular arc i relative to the pivot point P₂ of the right-hand screw profile in relation to the housing bore inner diameter D and y-coordinate of the center of the circular arc i relative to the pivot point P₂ of the right-hand screw profile relative to the housing bore inner diameter D. The crests of the practically scraping screw profile are the circular arcs 4′ and 10′. Kinks can be recognized by the fact that the value is

$$\frac{{r}_{i}}{D} = 0 .$$

TABLE 3
Circular arcs of the precisely scraping screw profile of the
right-hand screw element from example 1.

| i | αᵢ | β_{a,i} | β_{e,i} | $\frac{{r}_{i}}{D}$ | $\frac{{xm}_{i}}{D}$ | $\frac{{ym}_{i}}{D}$ |
|---|---|---|---|---|---|---|
| 1′ | 0.39943 | 2.94188 | 3.34131 | 0.33000 | 0.00000 | 0.00000 |
| 2′ | 0.58569 | 3.34131 | 3.92699 | 0.82500 | 0.48516 | 0.09820 |
| 3′ | 0.58569 | 3.92699 | 4.51268 | 0.00000 | −0.09820 | −0.48516 |
| 4′ | 0.39943 | 4.51268 | 4.91210 | 0.49500 | 0.00000 | 0.00000 |
| 5′ | 0.56361 | 4.91210 | 5.47571 | 0.00000 | 0.09820 | −0.48516 |
| 6′ | 0.57670 | 5.47571 | 6.05241 | 0.82500 | −0.47214 | 0.11094 |
| 7′ | 0.46235 | 6.05241 | 6.51475 | 0.34000 | 0.00000 | 0.00000 |
| 8′ | 0.55383 | 6.51475 | 7.06858 | 0.82500 | −0.47205 | −0.11131 |
| 9′ | 0.55383 | 7.06858 | 7.62242 | 0.00000 | 0.11131 | 0.47205 |
| 10′ | 0.46235 | 7.62242 | 8.08476 | 0.48500 | 0.00000 | 0.00000 |
| 11′ | 0.57670 | 8.08476 | 8.66146 | 0.00000 | −0.11094 | 0.47214 |
| 12′ | 0.56361 | 8.66146 | 9.22507 | 0.82500 | 0.48516 | −0.09820 |

The sum of the crest angles of both precisely scraping screw profiles of the pair of screw elements together is BKW0=1.72356 in radians (98.75°).

The technically executed, practically scraping screw elements of the pair of screw elements according to example 1 with screw profiles derived from precisely scraping screw profiles are asymmetrical, not congruent, but can be merged into one another by mirroring the axes and rotating them. The sum of the crest angles of the practically scraping screw profile of an individual screw element is 0.73115 in radians (41.89 degrees). The sum of the crest angles of the screw profiles of the pair of screw elements in radians is BKW=1.462 (83.78°).

The limit value calculated according to formula (2) for the sum of the crest angles of the pair of screw elements is BKGW=1.444 (82.71°). Thus BKW>BKGW, their ratio

$$f = \frac{BKW}{BKGW} = 1.012$$

and thus this pair of screw elements is not in accordance with the invention.

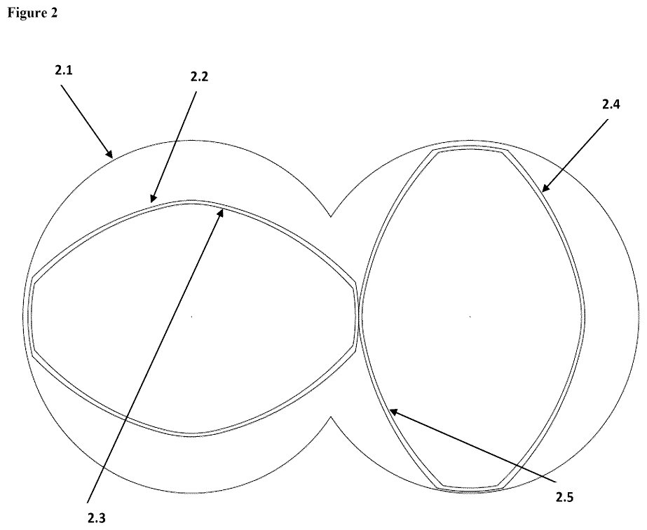

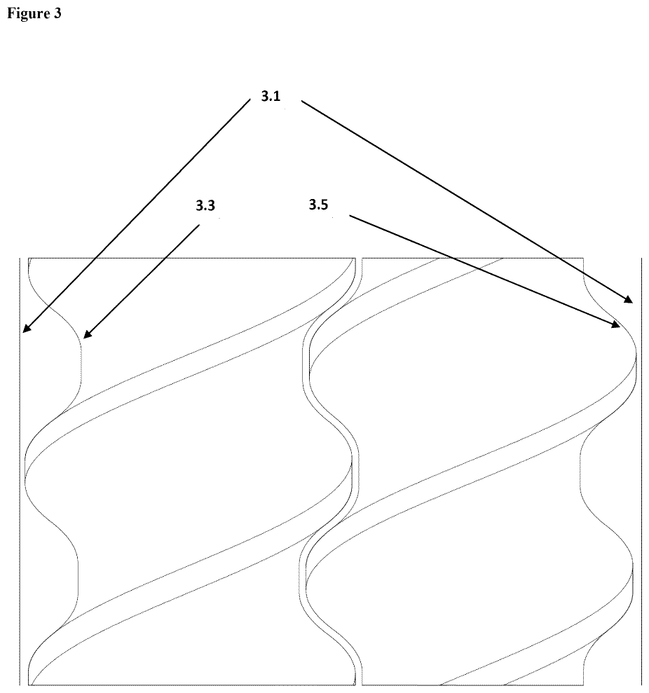

The practically scraping screw profiles of the two screw elements are shown in FIG. 2, together with the corresponding precisely scraping screw profiles from which the practically scraping screw profiles were derived. Table 4 shows the screw profile of the left-hand screw element in the plane according to formula (13), i.e. the radius as a function of the angle γₗ starting from the center of rotation P₁ of the left-hand screw element. The radii are each given for an angular distance of two degrees, except at the transition to a crest or groove area, where additional points are given. Table 5 shows the corresponding coordinates of the screw profile of the right-hand screw element starting from the center of rotation P₂ of the right-hand screw element; FIG. 3 shows a plan view of the pair of screw elements not according to the invention.

TABLE 4
Screw profile of the left-hand screw element of the pair of noninventive screw
elements from example 1.

| γ | $\frac{{r}_{l ( {γ}_{l} )}}{D}$ | γₗ | $\frac{{r}_{l ( {γ}_{l} )}}{D}$ | γₗ | $\frac{{r}_{l ( {γ}_{l} )}}{D}$ | γₗ | $\frac{{r}_{l ( {γ}_{l} )}}{D}$ | γₗ | $\frac{{r}_{l ( {γ}_{l} )}}{D}$ |
|---|---|---|---|---|---|---|---|---|---|
| 0.00 | 0.48500 | 74.00 | 0.32058 | 146.00 | 0.38123 | 218.00 | 0.37557 | 290.00 | 0.33131 |
| 2.00 | 0.48500 | 76.00 | 0.32018 | 148.00 | 0.38740 | 220.00 | 0.37072 | 292.00 | 0.33219 |
| 4.00 | 0.48500 | 78.00 | 0.32001 | 150.00 | 0.39394 | 222.00 | 0.36617 | 294.00 | 0.33331 |
| 6.00 | 0.48500 | 78.56 | 0.32000 | 152.00 | 0.40086 | 224.00 | 0.36193 | 296.00 | 0.33467 |
| 8.00 | 0.48500 | 80.00 | 0.32000 | 154.00 | 0.40818 | 226.00 | 0.35799 | 298.00 | 0.33626 |
| 9.53 | 0.48500 | 82.00 | 0.32000 | 156.00 | 0.41590 | 228.00 | 0.35433 | 300.00 | 0.33809 |
| 10.00 | 0.48238 | 84.00 | 0.32000 | 158.00 | 0.42404 | 230.00 | 0.35096 | 302.00 | 0.34017 |
| 12.00 | 0.47147 | 86.00 | 0.32000 | 160.00 | 0.43261 | 232.00 | 0.34786 | 304.00 | 0.34250 |
| 14.00 | 0.46105 | 88.00 | 0.32000 | 162.00 | 0.44163 | 234.00 | 0.34502 | 306.00 | 0.34508 |
| 16.00 | 0.45110 | 90.00 | 0.32000 | 164.00 | 0.45110 | 236.00 | 0.34244 | 308.00 | 0.34792 |
| 18.00 | 0.44163 | 92.00 | 0.32000 | 166.00 | 0.46105 | 238.00 | 0.34012 | 310.00 | 0.35103 |
| 20.00 | 0.43261 | 94.00 | 0.32000 | 168.00 | 0.47147 | 240.00 | 0.33805 | 312.00 | 0.35441 |
| 22.00 | 0.42404 | 96.00 | 0.32000 | 168.66 | 0.47500 | 242.00 | 0.33622 | 314.00 | 0.35808 |
| 24.00 | 0.41590 | 98.00 | 0.32000 | 170.00 | 0.47500 | 244.00 | 0.33464 | 316.00 | 0.36203 |
| 26.00 | 0.40818 | 100.00 | 0.32000 | 172.00 | 0.47500 | 246.00 | 0.33329 | 318.00 | 0.36627 |
| 28.00 | 0.40086 | 101.44 | 0.32000 | 174.00 | 0.47500 | 248.00 | 0.33217 | 320.00 | 0.37082 |
| 30.00 | 0.39394 | 102.00 | 0.32001 | 176.00 | 0.47500 | 250.00 | 0.33129 | 322.00 | 0.37569 |
| 32.00 | 0.38740 | 104.00 | 0.32018 | 178.00 | 0.47500 | 252.00 | 0.33064 | 324.00 | 0.38087 |
| 34.00 | 0.38123 | 106.00 | 0.32058 | 180.00 | 0.47500 | 254.00 | 0.33021 | 326.00 | 0.38639 |
| 36.00 | 0.37542 | 108.00 | 0.32121 | 182.00 | 0.47500 | 256.00 | 0.33002 | 328.00 | 0.39226 |
| 38.00 | 0.36995 | 110.00 | 0.32207 | 184.00 | 0.47500 | 256.73 | 0.33000 | 330.00 | 0.39848 |
| 40.00 | 0.36482 | 112.00 | 0.32315 | 186.00 | 0.47500 | 258.00 | 0.33000 | 332.00 | 0.40507 |
| 42.00 | 0.36001 | 114.00 | 0.32447 | 188.00 | 0.47500 | 260.00 | 0.33000 | 334.00 | 0.41203 |
| 44.00 | 0.35552 | 116.00 | 0.32602 | 190.00 | 0.47500 | 262.00 | 0.33000 | 336.00 | 0.41939 |
| 46.00 | 0.35133 | 118.00 | 0.32781 | 191.44 | 0.47500 | 264.00 | 0.33000 | 338.00 | 0.42714 |
| 48.00 | 0.34744 | 120.00 | 0.32984 | 192.00 | 0.47212 | 266.00 | 0.33000 | 340.00 | 0.43531 |
| 50.00 | 0.34383 | 122.00 | 0.33212 | 194.00 | 0.46219 | 268.00 | 0.33000 | 342.00 | 0.44391 |
| 52.00 | 0.34050 | 124.00 | 0.33465 | 196.00 | 0.45273 | 270.00 | 0.33000 | 344.00 | 0.45293 |
| 54.00 | 0.33745 | 126.00 | 0.33745 | 198.00 | 0.44371 | 272.00 | 0.33000 | 346.00 | 0.46241 |
| 56.00 | 0.33465 | 128.00 | 0.34050 | 200.00 | 0.43512 | 274.00 | 0.33000 | 348.00 | 0.47235 |
| 58.00 | 0.33212 | 130.00 | 0.34383 | 202.00 | 0.42696 | 276.00 | 0.33000 | 350.00 | 0.48275 |
| 60.00 | 0.32984 | 132.00 | 0.34744 | 204.00 | 0.41922 | 278.00 | 0.33000 | 350.42 | 0.48500 |
| 62.00 | 0.32781 | 134.00 | 0.35133 | 206.00 | 0.41187 | 280.00 | 0.33000 | 352.00 | 0.48500 |
| 64.00 | 0.32602 | 136.00 | 0.35552 | 208.00 | 0.40492 | 282.00 | 0.33000 | 354.00 | 0.48500 |
| 66.00 | 0.32447 | 138.00 | 0.36001 | 210.00 | 0.39834 | 283.22 | 0.33000 | 356.00 | 0.48500 |
| 68.00 | 0.32315 | 140.00 | 0.36482 | 212.00 | 0.39212 | 284.00 | 0.33002 | 358.00 | 0.48500 |
| 70.00 | 0.32207 | 142.00 | 0.36995 | 214.00 | 0.38627 | 286.00 | 0.33022 | | |
| 72.00 | 0.32121 | 144.00 | 0.37542 | 216.00 | 0.38075 | 288.00 | 0.33065 | | |

TABLE 5
Screw profile of the right-hand screw element of the
pair of noninventive screw elements from example 1.

| γ | r(γ)/D |
|---|---|
| 0.00 | 0.33000 |
| 2.00 | 0.33000 |
| 4.00 | 0.33000 |
| 6.00 | 0.33000 |
| 8.00 | 0.33000 |
| 10.00 | 0.33000 |
| 12.00 | 0.33000 |
| 13.27 | 0.33000 |
| 14.00 | 0.33002 |
| 16.00 | 0.33021 |
| 18.00 | 0.33064 |
| 20.00 | 0.33129 |
| 22.00 | 0.33217 |
| 24.00 | 0.33329 |
| 26.00 | 0.33464 |
| 28.00 | 0.33622 |
| 30.00 | 0.33805 |
| 32.00 | 0.34012 |
| 34.00 | 0.34244 |
| 36.00 | 0.34502 |
| 38.00 | 0.34786 |
| 40.00 | 0.35096 |
| 42.00 | 0.35433 |
| 44.00 | 0.35799 |
| 46.00 | 0.36193 |
| 48.00 | 0.36617 |
| 50.00 | 0.37072 |
| 52.00 | 0.37557 |
| 54.00 | 0.38075 |
| 56.00 | 0.38627 |
| 58.00 | 0.39212 |
| 60.00 | 0.39834 |
| 62.00 | 0.40492 |
| 64.00 | 0.41187 |
| 66.00 | 0.41922 |
| 68.00 | 0.42696 |
| 70.00 | 0.43512 |
| 72.00 | 0.44371 |
| 74.00 | 0.45273 |
| 76.00 | 0.46219 |
| 78.00 | 0.47212 |
| 78.56 | 0.47500 |
| 80.00 | 0.47500 |
| 82.00 | 0.47500 |
| 84.00 | 0.47500 |
| 86.00 | 0.47500 |
| 88.00 | 0.47500 |
| 90.00 | 0.47500 |
| 92.00 | 0.47500 |
| 94.00 | 0.47500 |
| 96.00 | 0.47500 |
| 98.00 | 0.47500 |
| 100.00 | 0.47500 |
| 101.34 | 0.47500 |
| 102.00 | 0.47147 |
| 104.00 | 0.46105 |
| 106.00 | 0.45110 |
| 108.00 | 0.44163 |
| 110.00 | 0.43261 |
| 112.00 | 0.42404 |
| 114.00 | 0.41590 |
| 116.00 | 0.40818 |
| 118.00 | 0.40086 |
| 120.00 | 0.39394 |
| 122.00 | 0.38740 |
| 124.00 | 0.38123 |
| 126.00 | 0.37542 |
| 128.00 | 0.36995 |
| 130.00 | 0.36482 |
| 132.00 | 0.36001 |
| 134.00 | 0.35552 |
| 136.00 | 0.35133 |
| 138.00 | 0.34744 |
| 140.00 | 0.34383 |
| 142.00 | 0.34050 |
| 144.00 | 0.33745 |
| 146.00 | 0.33465 |
| 148.00 | 0.33212 |
| 150.00 | 0.32984 |
| 152.00 | 0.32781 |
| 154.00 | 0.32602 |
| 156.00 | 0.32447 |
| 158.00 | 0.32315 |
| 160.00 | 0.32207 |
| 162.00 | 0.32121 |
| 164.00 | 0.32058 |
| 166.00 | 0.32018 |
| 168.00 | 0.32001 |
| 168.56 | 0.32000 |
| 170.00 | 0.32000 |
| 172.00 | 0.32000 |
| 174.00 | 0.32000 |
| 176.00 | 0.32000 |
| 178.00 | 0.32000 |
| 180.00 | 0.32000 |
| 182.00 | 0.32000 |
| 184.00 | 0.32000 |
| 186.00 | 0.32000 |
| 188.00 | 0.32000 |
| 190.00 | 0.32000 |
| 191.44 | 0.32000 |
| 192.00 | 0.32001 |
| 194.00 | 0.32018 |
| 196.00 | 0.32058 |
| 198.00 | 0.32121 |
| 200.00 | 0.32207 |
| 202.00 | 0.32315 |
| 204.00 | 0.32447 |
| 206.00 | 0.32602 |
| 208.00 | 0.32781 |
| 210.00 | 0.32984 |
| 212.00 | 0.33212 |
| 214.00 | 0.33465 |
| 216.00 | 0.33745 |
| 218.00 | 0.34050 |
| 220.00 | 0.34383 |
| 222.00 | 0.34744 |
| 224.00 | 0.35133 |
| 226.00 | 0.35552 |
| 228.00 | 0.36001 |
| 230.00 | 0.36482 |
| 232.00 | 0.36995 |
| 234.00 | 0.37542 |
| 236.00 | 0.38123 |
| 238.00 | 0.38740 |
| 240.00 | 0.39394 |
| 242.00 | 0.40086 |
| 244.00 | 0.40818 |
| 246.00 | 0.41590 |
| 248.00 | 0.42404 |
| 250.00 | 0.43261 |
| 252.00 | 0.44163 |
| 254.00 | 0.45110 |
| 256.00 | 0.46105 |
| 258.00 | 0.47147 |
| 260.00 | 0.48238 |
| 260.47 | 0.48500 |
| 262.00 | 0.48500 |
| 264.00 | 0.48500 |
| 266.00 | 0.48500 |
| 268.00 | 0.48500 |
| 270.00 | 0.48500 |
| 272.00 | 0.48500 |
| 274.00 | 0.48500 |
| 276.00 | 0.48500 |
| 278.00 | 0.48500 |
| 279.58 | 0.48500 |
| 280.00 | 0.48275 |
| 282.00 | 0.47235 |
| 284.00 | 0.46241 |
| 286.00 | 0.45293 |
| 288.00 | 0.44391 |
| 290.00 | 0.43531 |
| 292.00 | 0.42714 |
| 294.00 | 0.41939 |
| 296.00 | 0.41203 |
| 298.00 | 0.40507 |
| 300.00 | 0.39848 |
| 302.00 | 0.39226 |
| 304.00 | 0.38639 |
| 306.00 | 0.38087 |
| 308.00 | 0.37569 |
| 310.00 | 0.37082 |
| 312.00 | 0.36627 |
| 314.00 | 0.36203 |
| 316.00 | 0.35808 |
| 318.00 | 0.35441 |
| 320.00 | 0.35103 |
| 322.00 | 0.34792 |
| 324.00 | 0.34508 |
| 326.00 | 0.34250 |
| 328.00 | 0.34017 |
| 330.00 | 0.33809 |
| 332.00 | 0.33626 |
| 334.00 | 0.33467 |
| 336.00 | 0.33331 |
| 338.00 | 0.33219 |
| 340.00 | 0.33131 |
| 342.00 | 0.33065 |
| 344.00 | 0.33022 |
| 346.00 | 0.33002 |
| 346.78 | 0.33000 |
| 348.00 | 0.33000 |
| 350.00 | 0.33000 |
| 352.00 | 0.33000 |
| 354.00 | 0.33000 |
| 356.00 | 0.33000 |
| 358.00 | 0.33000 |

### Example 2 (Inventive)

Example 2 according to the invention is a pair of two mutually practically scraping screw elements with

$$\frac{A}{D} = 0.825 , T / D = 1.2 , \frac{δ}{D} = 0.015 , \frac{s}{D} = 0.02 and \frac{SP}{D} = 0.01 ,$$

i.e. the same values for the corresponding variables as in example 1, wherein the spatial equidistant calculation rule is additionally applied. The screw profiles of the screw elements are asymmetrical, not congruent, but they can be merged into one another by mirroring the axes and rotating them.

The precisely scraping screw profile of the left screw element consists of the sections i=1 to 20, which are either circular arcs or kinks. The circular arcs, start angle, end angle, arc radius relative to the housing bore inner diameter D, x-coordinate of the center of the circular arc i relative to the pivot point of the left-hand screw profile P₁ relative to the housing bore inner diameter D and y-coordinate of the center of the circular arc i relative to the pivot point P₁ of the left-hand screw profile relative to the housing bore inner diameter D are given in table 6. The crests of the precisely scraping screw profile are the circular arcs 1 and 11. Kinks can be recognized by the fact that the value is

$$\frac{{r}_{i}}{D} = 0 .$$

The precisely scraping screw profile of the right-hand screw element consists of the circular arcs i=1′ to 20′, which are either circular arcs or kinks. The circular arcs, start angle, end angle, arc radius relative to the housing bore inner diameter D, x-coordinate of the center of the circular arc i relative to the pivot point P₂ of the right-hand screw profile relative to the housing bore inner diameter D and y-coordinate of the center of the circular arc i relative to the pivot point P₂ of the right-hand screw profile relative to the housing bore inner diameter D are given in table 7. The crests of the practically scraping screw profile are the circular arcs 6′ and 16′. The sum of the crest angles of both precisely scraping screw profiles of the pair of screw elements is BKW0=0.8784 in radians (50.32°).

TABLE 6
Circular arcs of the precisely scraping screw profile of
the left-hand screw element from example 2.

| i | αᵢ | β_{a,i} | β_{e,i} | $\frac{{r}_{i}}{D}$ | $\frac{{xm}_{i}}{D}$ | $\frac{y {m}_{i}}{D}$ |
|---|---|---|---|---|---|---|
| 1 | 0.13963 | −0.06981 | 0.06981 | 0.49500 | 0.00000 | 0.00000 |
| 2 | 0.39038 | 0.06981 | 0.46019 | 0.00000 | 0.49379 | 0.03453 |
| 3 | 0.32521 | 0.46019 | 0.78540 | 0.74250 | −0.17146 | −0.29523 |
| 4 | 0.32521 | 0.78540 | 1.11061 | 0.08250 | 0.29523 | 0.17146 |
| 5 | 0.39038 | 1.11061 | 1.50098 | 0.82500 | −0.03453 | −0.49379 |
| 6 | 0.13963 | 1.50098 | 1.64061 | 0.33000 | 0.00000 | 0.00000 |
| 7 | 0.40292 | 1.64061 | 2.04353 | 0.82500 | 0.03453 | −0.49379 |
| 8 | 0.31266 | 2.04353 | 2.35619 | 0.08250 | −0.30355 | 0.16727 |
| 9 | 0.26096 | 2.35619 | 2.61715 | 0.74250 | 0.16314 | −0.29942 |
| 10 | 0.37466 | 2.61715 | 2.99181 | 0.00000 | −0.47957 | 0.07237 |
| 11 | 0.29957 | 2.99181 | 3.29138 | 0.48500 | 0.00000 | 0.00000 |
| 12 | 0.39037 | 3.29138 | 3.68175 | 0.00000 | −0.47957 | −0.07237 |
| 13 | 0.24524 | 3.68175 | 3.92699 | 0.74250 | 0.15722 | 0.30947 |
| 14 | 0.24524 | 3.92699 | 4.17223 | 0.08250 | −0.30947 | −0.15722 |
| 15 | 0.39037 | 4.17223 | 4.56260 | 0.82500 | 0.07237 | 0.47957 |
| 16 | 0.29957 | 4.56260 | 4.86217 | 0.34000 | 0.00000 | 0.00000 |
| 17 | 0.37466 | 4.86217 | 5.23683 | 0.82500 | −0.07237 | 0.47957 |
| 18 | 0.26096 | 5.23683 | 5.49779 | 0.08250 | 0.29942 | −0.16314 |
| 19 | 0.31266 | 5.49779 | 5.81045 | 0.74250 | −0.16727 | 0.30355 |
| 20 | 0.40292 | 5.81045 | 6.21337 | 0.00000 | 0.49379 | −0.03453 |

TABLE 7
Circular arcs of the precisely scraping screw profile of
the right-hand screw element from example 2.

| i | αi | βa,i | βe,i | $\frac{{r}_{i}}{D}$ | $\frac{{xm}_{i}}{D}$ | $\frac{y {m}_{i}}{D}$ |
|---|---|---|---|---|---|---|
| 1′ | 0.13963 | 3.07178 | 3.21141 | 0.33000 | 0.00000 | 0.00000 |
| 2′ | 0.39038 | 3.21141 | 3.60178 | 0.82500 | 0.49379 | 0.03453 |
| 3′ | 0.32521 | 3.60178 | 3.92699 | 0.08250 | −0.17146 | −0.29523 |
| 4′ | 0.32521 | 3.92699 | 4.25220 | 0.74250 | 0.29523 | 0.17146 |
| 5′ | 0.39038 | 4.25220 | 4.64258 | 0.00000 | −0.03453 | −0.49379 |
| 6′ | 0.13963 | 4.64258 | 4.78220 | 0.49500 | 0.00000 | 0.00000 |
| 7′ | 0.40292 | 4.78220 | 5.18513 | 0.00000 | 0.03453 | −0.49379 |
| 8′ | 0.31266 | 5.18513 | 5.49779 | 0.74250 | −0.30355 | 0.16727 |
| 9′ | 0.26096 | 5.49779 | 5.75874 | 0.08250 | 0.16314 | −0.29942 |
| 10′ | 0.37466 | 5.75874 | 6.13340 | 0.82500 | −0.47957 | 0.07237 |
| 11′ | 0.29957 | 6.13340 | 6.43297 | 0.34000 | 0.00000 | 0.00000 |
| 12′ | 0.39037 | 6.43297 | 6.82334 | 0.82500 | −0.47957 | −0.07237 |
| 13′ | 0.24524 | 6.82334 | 7.06858 | 0.08250 | 0.15722 | 0.30947 |
| 14′ | 0.24524 | 7.06858 | 7.31383 | 0.74250 | −0.30947 | −0.15722 |
| 15 | 0.39037 | 7.31383 | 7.70420 | 0.00000 | 0.07237 | 0.47957 |
| 16′ | 0.29957 | 7.70420 | 8.00377 | 0.48500 | 0.00000 | 0.00000 |
| 17′ | 0.37466 | 8.00377 | 8.37842 | 0.00000 | −0.07237 | 0.47957 |
| 18′ | 0.26096 | 8.37842 | 8.63938 | 0.74250 | 0.29942 | −0.16314 |
| 19′ | 0.31266 | 8.63938 | 8.95204 | 0.08250 | −0.16727 | 0.30355 |
| 20 | 0.40292 | 8.95204 | 9.35496 | 0.82500 | 0.49379 | −0.03453 |

The technically executed, practically scraping screw elements of the pair of screw elements according to example 2 with screw profiles derived from precisely scraping screw profiles are asymmetrical, not congruent, but can be merged into one another by mirroring the axes and rotating them. The sum of the crest angles of the practically scraping screw profile of an individual screw element is 0.3384 in radians (19.30°). The sum of the crest angles of the screw profiles of the pair of screw elements is BKW=0.6769 in radians (38.78°). The limit value calculated according to formula (2) for the sum of the crest angles of the pair of screw elements is (as in example 1) BKGW=1.444 in radians (82.71°). Thus, BKW<BKGW, the ratio is

$$f = \frac{BKW}{BKGW} = 0.469 ,$$

and this screw element pair is inventive.

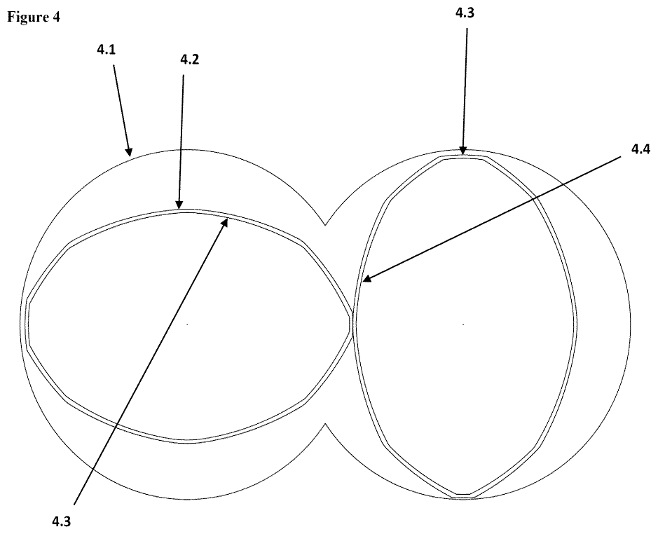

The practically scraping screw profiles of the pair of screw elements according to the invention are shown in FIG. 4, together with the corresponding precisely scraping screw profiles from which the practically scraping screw profiles were derived. Table 8 shows the screw profile of the left-hand screw element in the plane according to formula (5), i.e. the radius as a function of the angle γₗ starting from the center of rotation P₁ of the left-hand screw element. The radii are each given for an angular distance of two degrees, except at the transition to a crest or groove area, where additional points are given. Table 9 shows the corresponding coordinates of the screw profile of the right-hand screw element; FIG. 5 shows a plan view of the pair of screw elements according to the invention.

TABLE 8
Screw profile of the left-hand screw element of the
pair of inventive screw elements from example 2.

| γ | r(γ)/D |
|---|---|
| 0.00 | 0.48500 |
| 2.00 | 0.48500 |
| 2.55 | 0.48500 |
| 4.00 | 0.48001 |
| 6.00 | 0.47338 |
| 8.00 | 0.46704 |
| 10.00 | 0.46099 |
| 12.00 | 0.45521 |
| 14.00 | 0.44972 |
| 16.00 | 0.44449 |
| 18.00 | 0.43954 |
| 20.00 | 0.43485 |
| 22.00 | 0.43042 |
| 24.00 | 0.42624 |
| 26.00 | 0.42232 |
| 28.00 | 0.41865 |
| 30.00 | 0.41522 |
| 31.48 | 0.41284 |
| 32.00 | 0.41192 |
| 33.88 | 0.40654 |
| 34.00 | 0.40610 |
| 36.00 | 0.39889 |
| 38.00 | 0.39208 |
| 40.00 | 0.38564 |
| 42.00 | 0.37958 |
| 44.00 | 0.37386 |
| 46.00 | 0.36849 |
| 48.00 | 0.36345 |
| 50.00 | 0.35873 |
| 52.00 | 0.35432 |
| 54.00 | 0.35022 |
| 56.00 | 0.34640 |
| 58.00 | 0.34287 |
| 60.00 | 0.33962 |
| 62.00 | 0.33664 |
| 64.00 | 0.33392 |
| 66.00 | 0.33146 |
| 68.00 | 0.32925 |
| 70.00 | 0.32728 |
| 72.00 | 0.32556 |
| 74.00 | 0.32408 |
| 76.00 | 0.32282 |
| 78.00 | 0.32180 |
| 80.00 | 0.32101 |
| 82.00 | 0.32045 |
| 84.00 | 0.32011 |
| 86.00 | 0.32000 |
| 88.00 | 0.32000 |
| 90.00 | 0.32000 |
| 92.00 | 0.32000 |
| 94.00 | 0.32000 |
| 96.00 | 0.32011 |
| 98.00 | 0.32045 |
| 100.00 | 0.32101 |
| 102.00 | 0.32180 |
| 104.00 | 0.32282 |
| 106.00 | 0.32408 |
| 108.00 | 0.32556 |
| 110.00 | 0.32728 |
| 112.00 | 0.32925 |
| 114.00 | 0.33146 |
| 116.00 | 0.33392 |
| 118.00 | 0.33664 |
| 120.00 | 0.33962 |
| 122.00 | 0.34287 |
| 124.00 | 0.34640 |
| 126.00 | 0.35022 |
| 128.00 | 0.35432 |
| 130.00 | 0.35873 |
| 132.00 | 0.36345 |
| 134.00 | 0.36849 |
| 136.00 | 0.37386 |
| 138.00 | 0.37958 |
| 140.00 | 0.38564 |
| 142.00 | 0.39208 |
| 144.00 | 0.39889 |
| 146.00 | 0.40610 |
| 147.41 | 0.41143 |
| 148.00 | 0.41351 |
| 149.72 | 0.41781 |
| 150.00 | 0.41830 |
| 152.00 | 0.42192 |
| 154.00 | 0.42579 |
| 156.00 | 0.42990 |
| 158.00 | 0.43427 |
| 160.00 | 0.43891 |
| 162.00 | 0.44380 |
| 164.00 | 0.44896 |
| 166.00 | 0.45440 |
| 168.00 | 0.46011 |
| 170.00 | 0.46609 |
| 172.00 | 0.47237 |
| 172.81 | 0.47500 |
| 174.00 | 0.47500 |
| 176.00 | 0.47500 |
| 178.00 | 0.47500 |
| 180.00 | 0.47500 |
| 182.00 | 0.47500 |
| 184.00 | 0.47500 |
| 186.00 | 0.47500 |
| 187.14 | 0.47500 |
| 188.00 | 0.47210 |
| 190.00 | 0.46553 |
| 192.00 | 0.45926 |
| 194.00 | 0.45327 |
| 196.00 | 0.44757 |
| 198.00 | 0.44215 |
| 200.00 | 0.43700 |
| 202.00 | 0.43212 |
| 204.00 | 0.42751 |
| 206.00 | 0.42316 |
| 208.00 | 0.41907 |
| 208.57 | 0.41795 |
| 210.00 | 0.41426 |
| 210.38 | 0.41297 |
| 212.00 | 0.40726 |
| 214.00 | 0.40055 |
| 216.00 | 0.39421 |
| 218.00 | 0.38824 |
| 220.00 | 0.38260 |
| 222.00 | 0.37731 |
| 224.00 | 0.37234 |
| 226.00 | 0.36769 |
| 228.00 | 0.36335 |
| 230.00 | 0.35931 |
| 232.00 | 0.35556 |
| 234.00 | 0.35209 |
| 236.00 | 0.34889 |
| 238.00 | 0.34596 |
| 240.00 | 0.34330 |
| 242.00 | 0.34089 |
| 244.00 | 0.33873 |
| 246.00 | 0.33682 |
| 248.00 | 0.33515 |
| 250.00 | 0.33372 |
| 252.00 | 0.33253 |
| 254.00 | 0.33157 |
| 256.00 | 0.33083 |
| 258.00 | 0.33033 |
| 260.00 | 0.33006 |
| 261.42 | 0.33000 |
| 262.00 | 0.33000 |
| 264.00 | 0.33000 |
| 266.00 | 0.33000 |
| 268.00 | 0.33000 |
| 270.00 | 0.33000 |
| 272.00 | 0.33000 |
| 274.00 | 0.33000 |
| 276.00 | 0.33000 |
| 278.00 | 0.33000 |
| 278.58 | 0.33000 |
| 280.00 | 0.33006 |
| 282.00 | 0.33033 |
| 284.00 | 0.33083 |
| 286.00 | 0.33157 |
| 288.00 | 0.33253 |
| 290.00 | 0.33372 |
| 292.00 | 0.33515 |
| 294.00 | 0.33682 |
| 296.00 | 0.33873 |
| 298.00 | 0.34089 |
| 300.00 | 0.34330 |
| 302.00 | 0.34596 |
| 304.00 | 0.34889 |
| 306.00 | 0.35209 |
| 308.00 | 0.35556 |
| 310.00 | 0.35931 |
| 312.00 | 0.36335 |
| 314.00 | 0.36769 |
| 316.00 | 0.37234 |
| 318.00 | 0.37731 |
| 320.00 | 0.38260 |
| 322.00 | 0.38824 |
| 324.00 | 0.39421 |
| 326.00 | 0.40055 |
| 327.97 | 0.40717 |
| 328.00 | 0.40726 |
| 329.90 | 0.41213 |
| 330.00 | 0.41230 |
| 332.00 | 0.41589 |
| 334.00 | 0.41974 |
| 336.00 | 0.42384 |
| 338.00 | 0.42820 |
| 340.00 | 0.43282 |
| 342.00 | 0.43770 |
| 344.00 | 0.44286 |
| 346.00 | 0.44829 |
| 348.00 | 0.45400 |
| 350.00 | 0.45999 |
| 352.00 | 0.46627 |
| 354.00 | 0.47284 |
| 356.00 | 0.47970 |
| 357.49 | 0.48500 |
| 358.00 | 0.48500 |

TABLE 9
Screw profile of the right-hand screw element of the
inventive pair of screw elements from example 2.

| γ | r(γ)/D |
|---|---|
| 0.00 | 0.33000 |
| 2.00 | 0.33000 |
| 4.00 | 0.33000 |
| 6.00 | 0.33000 |
| 8.00 | 0.33000 |
| 8.58 | 0.33000 |
| 10.00 | 0.33006 |
| 12.00 | 0.33033 |
| 14.00 | 0.33083 |
| 16.00 | 0.33157 |
| 18.00 | 0.33253 |
| 20.00 | 0.33372 |
| 22.00 | 0.33515 |
| 24.00 | 0.33682 |
| 26.00 | 0.33873 |
| 28.00 | 0.34089 |
| 30.00 | 0.34330 |
| 32.00 | 0.34596 |
| 34.00 | 0.34889 |
| 36.00 | 0.35209 |
| 38.00 | 0.35556 |
| 40.00 | 0.35931 |
| 42.00 | 0.36335 |
| 44.00 | 0.36769 |
| 46.00 | 0.37234 |
| 48.00 | 0.37731 |
| 50.00 | 0.38260 |
| 52.00 | 0.38824 |
| 54.00 | 0.39421 |
| 56.00 | 0.40055 |
| 58.00 | 0.40726 |
| 59.62 | 0.41297 |
| 60.00 | 0.41426 |
| 61.43 | 0.41795 |
| 62.00 | 0.41907 |
| 64.00 | 0.42316 |
| 66.00 | 0.42751 |
| 68.00 | 0.43212 |
| 70.00 | 0.43700 |
| 72.00 | 0.44215 |
| 74.00 | 0.44757 |
| 76.00 | 0.45327 |
| 78.00 | 0.45926 |
| 80.00 | 0.46553 |
| 82.00 | 0.47210 |
| 82.86 | 0.47500 |
| 84.00 | 0.47500 |
| 86.00 | 0.47500 |
| 88.00 | 0.47500 |
| 90.00 | 0.47500 |
| 92.00 | 0.47500 |
| 94.00 | 0.47500 |
| 96.00 | 0.47500 |
| 97.19 | 0.47500 |
| 98.00 | 0.47237 |
| 100.00 | 0.46609 |
| 102.00 | 0.46011 |
| 104.00 | 0.45440 |
| 106.00 | 0.44896 |
| 108.00 | 0.44380 |
| 110.00 | 0.43891 |
| 112.00 | 0.43427 |
| 114.00 | 0.42990 |
| 116.00 | 0.42579 |
| 118.00 | 0.42192 |
| 120.00 | 0.41830 |
| 120.28 | 0.41781 |
| 122.00 | 0.41351 |
| 122.59 | 0.41143 |
| 124.00 | 0.40610 |
| 126.00 | 0.39889 |
| 128.00 | 0.39208 |
| 130.00 | 0.38564 |
| 132.00 | 0.37958 |
| 134.00 | 0.37386 |
| 136.00 | 0.36849 |
| 138.00 | 0.36345 |
| 140.00 | 0.35873 |
| 142.00 | 0.35432 |
| 144.00 | 0.35022 |
| 146.00 | 0.34640 |
| 148.00 | 0.34287 |
| 150.00 | 0.33962 |
| 152.00 | 0.33664 |
| 154.00 | 0.33392 |
| 156.00 | 0.33146 |
| 158.00 | 0.32925 |
| 160.00 | 0.32728 |
| 162.00 | 0.32556 |
| 164.00 | 0.32408 |
| 166.00 | 0.32282 |
| 168.00 | 0.32180 |
| 170.00 | 0.32101 |
| 172.00 | 0.32045 |
| 174.00 | 0.32011 |
| 176.00 | 0.32000 |
| 178.00 | 0.32000 |
| 180.00 | 0.32000 |
| 182.00 | 0.32000 |
| 184.00 | 0.32000 |
| 186.00 | 0.32011 |
| 188.00 | 0.32045 |
| 190.00 | 0.32101 |
| 192.00 | 0.32180 |
| 194.00 | 0.32282 |
| 196.00 | 0.32408 |
| 198.00 | 0.32556 |
| 200.00 | 0.32728 |
| 202.00 | 0.32925 |
| 204.00 | 0.33146 |
| 206.00 | 0.33392 |
| 208.00 | 0.33664 |
| 210.00 | 0.33962 |
| 212.00 | 0.34287 |
| 214.00 | 0.34640 |
| 216.00 | 0.35022 |
| 218.00 | 0.35432 |
| 220.00 | 0.35873 |
| 222.00 | 0.36345 |
| 224.00 | 0.36849 |
| 226.00 | 0.37386 |
| 228.00 | 0.37958 |
| 230.00 | 0.38564 |
| 232.00 | 0.39208 |
| 234.00 | 0.39889 |
| 236.00 | 0.40610 |
| 236.12 | 0.40654 |
| 238.00 | 0.41192 |
| 238.52 | 0.41284 |
| 240.00 | 0.41522 |
| 242.00 | 0.41865 |
| 244.00 | 0.42232 |
| 246.00 | 0.42624 |
| 248.00 | 0.43042 |
| 250.00 | 0.43485 |
| 252.00 | 0.43954 |
| 254.00 | 0.44449 |
| 256.00 | 0.44972 |
| 258.00 | 0.45521 |
| 260.00 | 0.46099 |
| 262.00 | 0.46704 |
| 264.00 | 0.47338 |
| 266.00 | 0.48001 |
| 267.45 | 0.48500 |
| 268.00 | 0.48500 |
| 270.00 | 0.48500 |
| 272.00 | 0.48500 |
| 272.51 | 0.48500 |
| 274.00 | 0.47970 |
| 276.00 | 0.47284 |
| 278.00 | 0.46627 |
| 280.00 | 0.45999 |
| 282.00 | 0.45400 |
| 284.00 | 0.44829 |
| 286.00 | 0.44286 |
| 288.00 | 0.43770 |
| 290.00 | 0.43282 |
| 292.00 | 0.42820 |
| 294.00 | 0.42384 |
| 296.00 | 0.41974 |
| 298.00 | 0.41589 |
| 300.00 | 0.41230 |
| 300.10 | 0.41213 |
| 302.00 | 0.40726 |
| 302.03 | 0.40717 |
| 304.00 | 0.40055 |
| 306.00 | 0.39421 |
| 308.00 | 0.38824 |
| 310.00 | 0.38260 |
| 312.00 | 0.37731 |
| 314.00 | 0.37234 |
| 316.00 | 0.36769 |
| 318.00 | 0.36335 |
| 320.00 | 0.35931 |
| 322.00 | 0.35556 |
| 324.00 | 0.35209 |
| 326.00 | 0.34889 |
| 328.00 | 0.34596 |
| 330.00 | 0.34330 |
| 332.00 | 0.34089 |
| 334.00 | 0.33873 |
| 336.00 | 0.33682 |
| 338.00 | 0.33515 |
| 340.00 | 0.33372 |
| 342.00 | 0.33253 |
| 344.00 | 0.33157 |
| 346.00 | 0.33083 |
| 348.00 | 0.33033 |
| 350.00 | 0.33006 |
| 351.42 | 0.33000 |
| 352.00 | 0.33000 |
| 354.00 | 0.33000 |
| 356.00 | 0.33000 |
| 358.00 | 0.33000 |

### Example 3 (Inventive)

Example 3 according to the invention is a pair of two mutually practically scraping screw elements with

$$\frac{A}{D} = 0.805 , \frac{T}{D} = 5 , \frac{δ}{D} = 0.0 \; 15 and \frac{s}{D} = 0.02 ,$$

wherein additionally the spatial equidistant calculation rule was applied. The screw profiles of the screw elements are asymmetrical, not congruent, but they can be merged into one another by mirroring the axes and rotating them.

The precisely scraping screw profile of the left screw element consists of the sections i=1 to 20, which are either circular arcs or kinks. The circular arcs, start angle, end angle, arc radius relative to the housing bore inner diameter D, x-coordinate of the center of the circular arc i relative to the pivot point P₁ of the left-hand screw profile relative to the housing bore inner diameter D and y-coordinate of the center of the circular arc i relative to the pivot point P₁ of the left-hand screw profile relative to the housing bore inner diameter D are given in table 10. The crests of the precisely scraping screw profile are the circular arcs 1 and 11. Kinks can be recognized by the fact that the value is

$$\frac{{r}_{i}}{D} = 0 .$$

The crests of the practically scraping screw profile are the circular arcs 1 and 11.

TABLE 10
Circular arcs of the precisely scraping profile of
the left-hand screw profile from example 3.

| i | αi | βa,i | βe,i | $\frac{{r}_{i}}{D}$ | $\frac{{xm}_{i}}{D}$ | $\frac{y {m}_{i}}{D}$ |
|---|---|---|---|---|---|---|
| 1 | 0.13963 | -0.06981 | 0.06981 | 0.49500 | 0.00000 | 0.00000 |
| 2 | 0.39038 | 0.06981 | 0.46019 | 0.00000 | 0.49379 | 0.03453 |
| 3 | 0.32521 | 0.46019 | 0.78540 | 0.74250 | −0.17146 | −0.29523 |
| 4 | 0.32521 | 0.78540 | 1.11061 | 0.08250 | 0.29523 | 0.17146 |
| 5 | 0.39038 | 1.11061 | 1.50098 | 0.82500 | −0.03453 | −0.49379 |
| 6 | 0.13963 | 1.50098 | 1.64061 | 0.33000 | 0.00000 | 0.00000 |
| 7 | 0.40292 | 1.64061 | 2.04353 | 0.82500 | 0.03453 | −0.49379 |
| 8 | 0.31266 | 2.04353 | 2.35619 | 0.08250 | −0.30355 | 0.16727 |
| 9 | 0.26096 | 2.35619 | 2.61715 | 0.74250 | 0.16314 | −0.29942 |
| 10 | 0.37466 | 2.61715 | 2.99181 | 0.00000 | −0.47957 | 0.07237 |
| 11 | 0.29957 | 2.99181 | 3.29138 | 0.48500 | 0.00000 | 0.00000 |
| 12 | 0.39037 | 3.29138 | 3.68175 | 0.00000 | −0.47957 | −0.07237 |
| 13 | 0.24524 | 3.68175 | 3.92699 | 0.74250 | 0.15722 | 0.30947 |
| 14 | 0.24524 | 3.92699 | 4.17223 | 0.08250 | −0.30947 | −0.15722 |
| 15 | 0.39037 | 4.17223 | 4.56260 | 0.82500 | 0.07237 | 0.47957 |
| 16 | 0.29957 | 4.56260 | 4.86217 | 0.34000 | 0.00000 | 0.00000 |
| 17 | 0.37466 | 4.86217 | 5.23683 | 0.82500 | −0.07237 | 0.47957 |
| 18 | 0.26096 | 5.23683 | 5.49779 | 0.08250 | 0.29942 | −0.16314 |
| 19 | 0.31266 | 5.49779 | 5.81045 | 0.74250 | −0.16727 | 0.30355 |
| 20 | 0.40292 | 5.81045 | 6.21337 | 0.00000 | 0.49379 | −0.03453 |

The precisely scraping screw profile of the right-hand screw element consists of the circular arcs i=1′ to 20′, which are either circular arcs or kinks. The circular arcs, start angle, end angle, arc radius relative to the housing bore inner diameter D, x-coordinate of the center of the circular arc i relative to the pivot point P₂ of the right-hand screw profile relative to the housing bore inner diameter D and y-coordinate of the center of the circular arc i relative to the pivot point P₂ of the right-hand screw profile relative to the housing bore inner diameter D are given in table 11. The crests of the precisely scraping screw profile are the circular arcs 6′ and 16′. The sum of the crest angles of both precisely scraping profiles is BKW0=0.7716 in radians (44.21°)

TABLE 11
Circular arcs of the precisely scraping profile of the
right-hand screw profile from example 3.

| i | αi | βa,i | βe,i | $\frac{{r}_{i}}{D}$ | $\frac{{x}_{m , i}}{D}$ | $\frac{{y}_{m , i}}{D}$ |
|---|---|---|---|---|---|---|
| 1 | 0.13963 | 3.07178 | 3.21141 | 0.31000 | 0.00000 | 0.00000 |
| 2 | 0.43209 | 3.21141 | 3.64350 | 0.80500 | 0.49379 | 0.03453 |
| 3 | 0.28349 | 3.64350 | 3.92699 | 0.08050 | −0.14135 | −0.29523 |
| 4 | 0.28349 | 3.92699 | 4.21048 | 0.72450 | 0.31403 | 0.17146 |
| 5 | 0.43209 | 4.21048 | 4.64258 | 0.00000 | −0.03453 | −0.49379 |
| 6 | 0.13963 | 4.64258 | 4.78220 | 0.49500 | 0.00000 | 0.00000 |
| 7 | 0.35589 | 4.78220 | 5.13810 | 0.00000 | 0.03453 | −0.49379 |
| 8 | 0.35969 | 5.13810 | 5.49779 | 0.72450 | −0.26466 | 0.16727 |
| 9 | 0.28973 | 5.49779 | 5.78752 | 0.08050 | 0.19071 | −0.29942 |
| 10 | 0.37258 | 5.78752 | 6.16010 | 0.80500 | −0.44660 | 0.07237 |
| 11 | 0.24617 | 6.16010 | 6.40627 | 0.35500 | 0.00000 | 0.00000 |
| 12 | 0.29764 | 6.40627 | 6.70391 | 0.80500 | −0.44660 | −0.07237 |
| 13 | 0.36467 | 6.70391 | 7.06858 | 0.08050 | 0.21472 | 0.30947 |
| 14 | 0.36467 | 7.06858 | 7.43326 | 0.72450 | −0.24065 | −0.15722 |
| 15 | 0.29764 | 7.43326 | 7.73090 | 0.00000 | 0.05525 | 0.47957 |
| 16 | 0.24617 | 7.73090 | 7.97707 | 0.45000 | 0.00000 | 0.00000 |
| 17 | 0.37258 | 7.97707 | 8.34964 | 0.00000 | −0.05525 | 0.47957 |
| 18 | 0.28973 | 8.34964 | 8.63938 | 0.72450 | 0.28933 | −0.16314 |
| 19 | 0.35969 | 8.63938 | 8.99907 | 0.08050 | −0.16604 | 0.30355 |
| 20 | 0.35589 | 8.99907 | 9.35496 | 0.80500 | 0.49379 | −0.03453 |

The technically executed, practically scraping screw elements of the inventive pair of screw elements according to example 3 with screw profiles derived from precisely scraping screw profiles are likewise asymmetrical, not congruent, but can be merged into one another by mirroring the axes and rotating them. The sum of the crest angles for both the left and the right screw profile is 0.3464 in radians (20.89°); the sum of the crest angles of the pair of screw elements is therefore BKW=0.6928 (41.78°).

The limit value calculated according to formula (2) for the sum of the crest angles of the pair of screw elements is BKGW=1.848 in radians (105.86°). Thus BKW<BKGW, the ratio

$$f = \frac{BKW}{BKGW} = 0.375 ,$$

and the screw element pair is inventive.

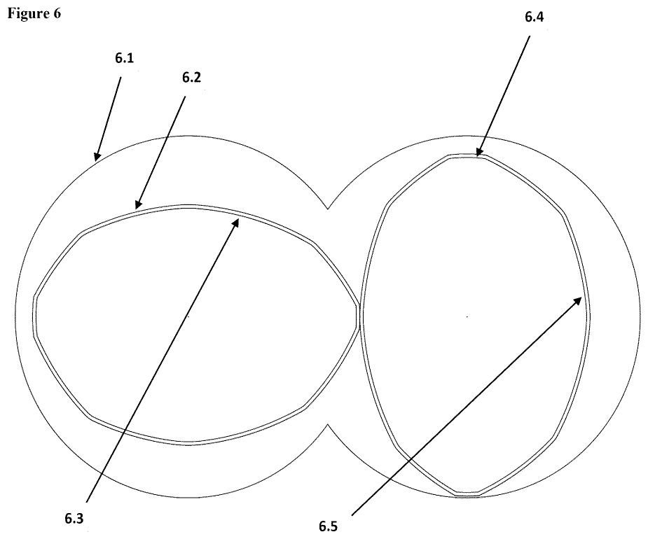

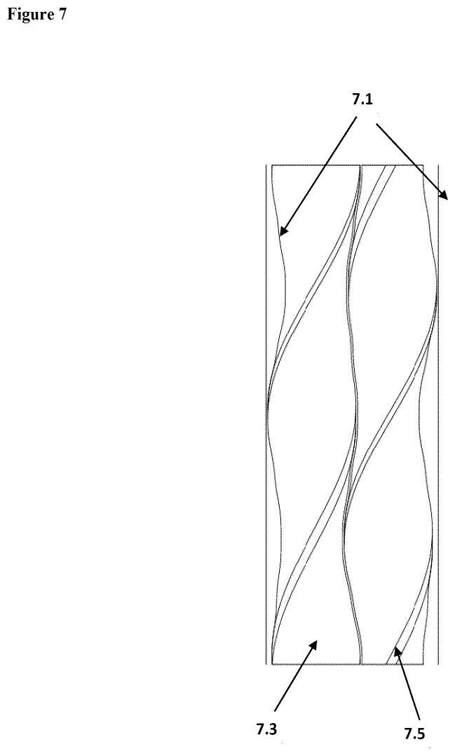

The practically scraping screw profiles of the pair of screw elements according to the invention are shown in FIG. 6, together with the corresponding precisely scraping screw profiles from which the practically scraping screw profiles were derived. Table 12 shows the screw profile of the left-hand screw element according to formula (5), i.e. the radius as a function of the angle γₗ starting from the center of rotation P₁ of the left-hand screw profile. The radii are each given for an angular distance of two degrees, except at the transition to a crest or groove area, where additional points are given. Table 13 shows the corresponding coordinates of the screw profile of the right-hand screw profile; FIG. 7 shows a plan view of the screw element pair according to the invention.

TABLE 12
Screw profile of the left-hand screw element of the
pair of inventive screw elements from example 3.

| γₗ | rₗ |
|---|---|
| 0.00 | 0.48500 |
| 2.00 | 0.48500 |
| 3.65 | 0.48500 |
| 4.00 | 0.48361 |
| 6.00 | 0.47587 |
| 8.00 | 0.46843 |
| 10.00 | 0.46130 |
| 12.00 | 0.45448 |
| 14.00 | 0.44795 |
| 16.00 | 0.44172 |
| 18.00 | 0.43578 |
| 20.00 | 0.43013 |
| 22.00 | 0.42476 |
| 24.00 | 0.41967 |
| 26.00 | 0.41486 |
| 27.61 | 0.41117 |
| 28.00 | 0.41025 |
| 30.00 | 0.40369 |
| 30.12 | 0.40320 |
| 32.00 | 0.39546 |
| 34.00 | 0.38765 |
| 36.00 | 0.38027 |
| 38.00 | 0.37329 |
| 40.00 | 0.36671 |
| 42.00 | 0.36051 |
| 44.00 | 0.35467 |
| 46.00 | 0.34919 |
| 48.00 | 0.34406 |
| 50.00 | 0.33925 |
| 52.00 | 0.33477 |
| 54.00 | 0.33060 |
| 56.00 | 0.32672 |
| 58.00 | 0.32314 |
| 60.00 | 0.31985 |
| 62.00 | 0.31683 |
| 64.00 | 0.31407 |
| 66.00 | 0.31158 |
| 68.00 | 0.30934 |
| 70.00 | 0.30736 |
| 72.00 | 0.30562 |
| 74.00 | 0.30412 |
| 76.00 | 0.30285 |
| 78.00 | 0.30182 |
| 80.00 | 0.30102 |
| 82.00 | 0.30045 |
| 84.00 | 0.30011 |
| 86.00 | 0.30000 |
| 88.00 | 0.30000 |
| 90.00 | 0.30000 |
| 92.00 | 0.30000 |
| 94.00 | 0.30000 |
| 96.00 | 0.30011 |
| 98.00 | 0.30045 |
| 100.00 | 0.30102 |
| 102.00 | 0.30182 |
| 104.00 | 0.30285 |
| 106.00 | 0.30412 |
| 108.00 | 0.30562 |
| 110.00 | 0.30736 |
| 112.00 | 0.30934 |
| 114.00 | 0.31158 |
| 116.00 | 0.31407 |
| 118.00 | 0.31683 |
| 120.00 | 0.31985 |
| 122.00 | 0.32314 |
| 124.00 | 0.32672 |
| 126.00 | 0.33060 |
| 128.00 | 0.33477 |
| 130.00 | 0.33925 |
| 132.00 | 0.34406 |
| 134.00 | 0.34919 |
| 136.00 | 0.35467 |
| 138.00 | 0.36051 |
| 140.00 | 0.36671 |
| 142.00 | 0.37329 |
| 142.05 | 0.37347 |
| 144.00 | 0.37883 |
| 145.60 | 0.38152 |
| 146.00 | 0.38203 |
| 148.00 | 0.38467 |
| 150.00 | 0.38755 |
| 152.00 | 0.39067 |
| 154.00 | 0.39405 |
| 156.00 | 0.39767 |
| 158.00 | 0.40154 |
| 160.00 | 0.40568 |
| 162.00 | 0.41008 |
| 164.00 | 0.41474 |
| 166.00 | 0.41968 |
| 168.00 | 0.42490 |
| 170.00 | 0.43040 |
| 172.00 | 0.43619 |
| 173.27 | 0.44000 |
| 174.00 | 0.44000 |
| 176.00 | 0.44000 |
| 178.00 | 0.44000 |
| 180.00 | 0.44000 |
| 182.00 | 0.44000 |
| 184.00 | 0.44000 |
| 186.00 | 0.44000 |
| 186.80 | 0.44000 |
| 188.00 | 0.43716 |
| 190.00 | 0.43265 |
| 192.00 | 0.42839 |
| 194.00 | 0.42439 |
| 196.00 | 0.42063 |
| 198.00 | 0.41712 |
| 200.00 | 0.41385 |
| 202.00 | 0.41081 |
| 204.00 | 0.40802 |
| 206.00 | 0.40545 |
| 208.00 | 0.40312 |
| 210.00 | 0.40101 |
| 212.00 | 0.39913 |
| 214.00 | 0.39747 |
| 216.00 | 0.39603 |
| 218.00 | 0.39481 |
| 220.00 | 0.39381 |
| 222.00 | 0.39303 |
| 222.31 | 0.39293 |
| 224.00 | 0.39157 |
| 225.89 | 0.38806 |
| 226.00 | 0.38779 |
| 228.00 | 0.38307 |
| 230.00 | 0.37865 |
| 232.00 | 0.37454 |
| 234.00 | 0.37072 |
| 236.00 | 0.36719 |
| 238.00 | 0.36394 |
| 240.00 | 0.36096 |
| 242.00 | 0.35825 |
| 244.00 | 0.35581 |
| 246.00 | 0.35362 |
| 248.00 | 0.35169 |
| 250.00 | 0.35001 |
| 252.00 | 0.34857 |
| 254.00 | 0.34738 |
| 256.00 | 0.34643 |
| 258.00 | 0.34573 |
| 260.00 | 0.34526 |
| 262.00 | 0.34503 |
| 262.95 | 0.34500 |
| 264.00 | 0.34500 |
| 266.00 | 0.34500 |
| 268.00 | 0.34500 |
| 270.00 | 0.34500 |
| 272.00 | 0.34500 |
| 274.00 | 0.34500 |
| 276.00 | 0.34500 |
| 277.05 | 0.34500 |
| 278.00 | 0.34503 |
| 280.00 | 0.34526 |
| 282.00 | 0.34573 |
| 284.00 | 0.34643 |
| 286.00 | 0.34738 |
| 288.00 | 0.34857 |
| 290.00 | 0.35001 |
| 292.00 | 0.35169 |
| 294.00 | 0.35362 |
| 296.00 | 0.35581 |
| 298.00 | 0.35825 |
| 300.00 | 0.36096 |
| 302.00 | 0.36394 |
| 304.00 | 0.36719 |
| 306.00 | 0.37072 |
| 308.00 | 0.37454 |
| 310.00 | 0.37865 |
| 312.00 | 0.38307 |
| 314.00 | 0.38779 |
| 316.00 | 0.39283 |
| 318.00 | 0.39820 |
| 320.00 | 0.40391 |
| 322.00 | 0.40995 |
| 322.08 | 0.41022 |
| 324.00 | 0.41482 |
| 324.72 | 0.41587 |
| 326.00 | 0.41750 |
| 328.00 | 0.42023 |
| 330.00 | 0.42320 |
| 332.00 | 0.42639 |
| 334.00 | 0.42983 |
| 336.00 | 0.43350 |
| 338.00 | 0.43742 |
| 340.00 | 0.44158 |
| 342.00 | 0.44599 |
| 344.00 | 0.45066 |
| 346.00 | 0.45557 |
| 348.00 | 0.46075 |
| 350.00 | 0.46618 |
| 352.00 | 0.47188 |
| 354.00 | 0.47785 |
| 356.00 | 0.48408 |
| 356.29 | 0.48500 |
| 358.00 | 0.48500 |

TABLE 13
Screw profile of the right-hand screw element of the
pair of inventive screw elements from example 3.

| γᵣ | rᵣ |
|---|---|
| 0.00 | 0.34500 |
| 2.00 | 0.34500 |
| 4.00 | 0.34500 |
| 6.00 | 0.34500 |
| 7.05 | 0.34500 |
| 8.00 | 0.34503 |
| 10.00 | 0.34526 |
| 12.00 | 0.34573 |
| 14.00 | 0.34643 |
| 16.00 | 0.34738 |
| 18.00 | 0.34857 |
| 20.00 | 0.35001 |
| 22.00 | 0.35169 |
| 24.00 | 0.35362 |
| 26.00 | 0.35581 |
| 28.00 | 0.35825 |
| 30.00 | 0.36096 |
| 32.00 | 0.36394 |
| 34.00 | 0.36719 |
| 36.00 | 0.37072 |
| 38.00 | 0.37454 |
| 40.00 | 0.37865 |
| 42.00 | 0.38307 |
| 44.00 | 0.38779 |
| 44.11 | 0.38806 |
| 46.00 | 0.39157 |
| 47.69 | 0.39293 |
| 48.00 | 0.39303 |
| 50.00 | 0.39381 |
| 52.00 | 0.39481 |
| 54.00 | 0.39603 |
| 56.00 | 0.39747 |
| 58.00 | 0.39913 |
| 60.00 | 0.40101 |
| 62.00 | 0.40312 |
| 64.00 | 0.40545 |
| 66.00 | 0.40802 |
| 68.00 | 0.41081 |
| 70.00 | 0.41385 |
| 72.00 | 0.41712 |
| 74.00 | 0.42063 |
| 76.00 | 0.42439 |
| 78.00 | 0.42839 |
| 80.00 | 0.43265 |
| 82.00 | 0.43716 |
| 83.20 | 0.44000 |
| 84.00 | 0.44000 |
| 86.00 | 0.44000 |
| 88.00 | 0.44000 |
| 90.00 | 0.44000 |
| 92.00 | 0.44000 |
| 94.00 | 0.44000 |
| 96.00 | 0.44000 |
| 96.73 | 0.44000 |
| 98.00 | 0.43619 |
| 100.00 | 0.43040 |
| 102.00 | 0.42490 |
| 104.00 | 0.41968 |
| 106.00 | 0.41474 |
| 108.00 | 0.41008 |
| 110.00 | 0.40568 |
| 112.00 | 0.40154 |
| 114.00 | 0.39767 |
| 116.00 | 0.39405 |
| 118.00 | 0.39067 |
| 120.00 | 0.38755 |
| 122.00 | 0.38467 |
| 124.00 | 0.38203 |
| 124.40 | 0.38152 |
| 126.00 | 0.37883 |
| 127.95 | 0.37347 |
| 128.00 | 0.37329 |
| 130.00 | 0.36671 |
| 132.00 | 0.36051 |
| 134.00 | 0.35467 |
| 136.00 | 0.34919 |
| 138.00 | 0.34406 |
| 140.00 | 0.33925 |
| 142.00 | 0.33477 |
| 144.00 | 0.33060 |
| 146.00 | 0.32672 |
| 148.00 | 0.32314 |
| 150.00 | 0.31985 |
| 152.00 | 0.31683 |
| 154.00 | 0.31407 |
| 156.00 | 0.31158 |
| 158.00 | 0.30934 |
| 160.00 | 0.30736 |
| 162.00 | 0.30562 |
| 164.00 | 0.30412 |
| 166.00 | 0.30285 |
| 168.00 | 0.30182 |
| 170.00 | 0.30102 |
| 172.00 | 0.30045 |
| 174.00 | 0.30011 |
| 176.00 | 0.30000 |
| 178.00 | 0.30000 |
| 180.00 | 0.30000 |
| 182.00 | 0.30000 |
| 184.00 | 0.30000 |
| 186.00 | 0.30011 |
| 188.00 | 0.30045 |
| 190.00 | 0.30102 |
| 192.00 | 0.30182 |
| 194.00 | 0.30285 |
| 196.00 | 0.30412 |
| 198.00 | 0.30562 |
| 200.00 | 0.30736 |
| 202.00 | 0.30934 |
| 204.00 | 0.31158 |
| 206.00 | 0.31407 |
| 208.00 | 0.31683 |
| 210.00 | 0.31985 |
| 212.00 | 0.32314 |
| 214.00 | 0.32672 |
| 216.00 | 0.33060 |
| 218.00 | 0.33477 |
| 220.00 | 0.33925 |
| 222.00 | 0.34406 |
| 224.00 | 0.34919 |
| 226.00 | 0.35467 |
| 228.00 | 0.36051 |
| 230.00 | 0.36671 |
| 232.00 | 0.37329 |
| 234.00 | 0.38027 |
| 236.00 | 0.38765 |
| 238.00 | 0.39546 |
| 239.88 | 0.40320 |
| 240.00 | 0.40369 |
| 242.00 | 0.41025 |
| 242.39 | 0.41117 |
| 244.00 | 0.41486 |
| 246.00 | 0.41967 |
| 248.00 | 0.42476 |
| 250.00 | 0.43013 |
| 252.00 | 0.43578 |
| 254.00 | 0.44172 |
| 256.00 | 0.44795 |
| 258.00 | 0.45448 |
| 260.00 | 0.46130 |
| 262.00 | 0.46843 |
| 264.00 | 0.47587 |
| 266.00 | 0.48361 |
| 266.35 | 0.48500 |
| 268.00 | 0.48500 |
| 270.00 | 0.48500 |
| 272.00 | 0.48500 |
| 273.71 | 0.48500 |
| 274.00 | 0.48408 |
| 276.00 | 0.47785 |
| 278.00 | 0.47188 |
| 280.00 | 0.46618 |
| 282.00 | 0.46075 |
| 284.00 | 0.45557 |
| 286.00 | 0.45066 |
| 288.00 | 0.44599 |
| 290.00 | 0.44158 |
| 292.00 | 0.43742 |
| 294.00 | 0.43350 |
| 296.00 | 0.42983 |
| 298.00 | 0.42639 |
| 300.00 | 0.42320 |
| 302.00 | 0.42023 |
| 304.00 | 0.41750 |
| 305.28 | 0.41587 |
| 306.00 | 0.41482 |
| 307.92 | 0.41022 |
| 308.00 | 0.40995 |
| 310.00 | 0.40391 |
| 312.00 | 0.39820 |
| 314.00 | 0.39283 |
| 316.00 | 0.38779 |
| 318.00 | 0.38307 |
| 320.00 | 0.37865 |
| 322.00 | 0.37454 |
| 324.00 | 0.37072 |
| 326.00 | 0.36719 |
| 328.00 | 0.36394 |
| 330.00 | 0.36096 |
| 332.00 | 0.35825 |
| 334.00 | 0.35581 |
| 336.00 | 0.35362 |
| 338.00 | 0.35169 |
| 340.00 | 0.35001 |
| 342.00 | 0.34857 |
| 344.00 | 0.34738 |
| 346.00 | 0.34643 |
| 348.00 | 0.34573 |
| 350.00 | 0.34526 |
| 352.00 | 0.34503 |
| 352.95 | 0.34500 |
| 354.00 | 0.34500 |
| 356.00 | 0.34500 |
| 358.00 | 0.34500 |

### Example 4 (Inventive)

Example 4 according to the invention is a pair of two mutually practically scraping screw elements with A/D=0.84, T/D=0.75, δ/d=0.005 and s/D=0.01, wherein additionally the spatial equidistant calculation rule is executed. The screw profiles of the screw elements are asymmetrical, not congruent, but they can be merged into one another by mirroring the axes and rotating them.

The precisely scraping screw profile of the left screw element consists of the sections i=1 to 20, which are either circular arcs or kinks. The circular arcs, start angle, end angle, arc radius relative to the housing bore inner diameter D, x-coordinate of the center of the circular arc i relative to the pivot point P₁ of the left-hand screw profile relative to the housing bore inner diameter D and y-coordinate of the center of the circular arc i relative to the pivot point P₁ of the left-hand screw profile relative to the housing bore inner diameter D are given in table 14. The crests of the precisely scraping screw profile are the circular arcs 1 and 11. Kinks can be recognized by the fact that the value is

$$\frac{{r}_{i}}{D} = 0 .$$

TABLE 14
Circular arcs of the practically scraping screw profile
of the left-hand screw element from example 4.

| i | αi | βa,i | βe,i | $\frac{{r}_{i}}{D}$ | $\frac{{xm}_{i}}{D}$ | $\frac{y {m}_{i}}{D}$ |
|---|---|---|---|---|---|---|
| 1 | 0.13963 | −0.06981 | 0.06981 | 0.50000 | 0.00000 | 0.00000 |
| 2 | 0.35741 | 0.06981 | 0.42723 | 0.00000 | 0.49878 | 0.03488 |
| 3 | 0.35817 | 0.42723 | 0.78540 | 0.67200 | −0.11282 | −0.24356 |
| 4 | 0.35817 | 0.78540 | 1.14357 | 0.16800 | 0.24356 | 0.11282 |
| 5 | 0.35741 | 1.14357 | 1.50098 | 0.84000 | −0.03488 | −0.49878 |
| 6 | 0.13963 | 1.50098 | 1.64061 | 0.34000 | 0.00000 | 0.00000 |
| 7 | 0.32821 | 1.64061 | 1.96882 | 0.84000 | 0.03488 | −0.49878 |
| 8 | 0.38737 | 1.96882 | 2.35619 | 0.16800 | −0.22559 | 0.12069 |
| 9 | 0.34599 | 2.35619 | 2.70219 | 0.67200 | 0.13079 | −0.23570 |
| 10 | 0.33468 | 2.70219 | 3.03687 | 0.00000 | −0.47737 | 0.05017 |
| 11 | 0.20944 | 3.03687 | 3.24631 | 0.48000 | 0.00000 | 0.00000 |
| 12 | 0.30458 | 3.24631 | 3.55089 | 0.00000 | −0.47737 | −0.05017 |
| 13 | 0.37610 | 3.55089 | 3.92699 | 0.67200 | 0.13912 | 0.21726 |
| 14 | 0.37610 | 3.92699 | 4.30309 | 0.16800 | −0.21726 | −0.13912 |
| 15 | 0.30458 | 4.30309 | 4.60767 | 0.84000 | 0.05017 | 0.47737 |
| 16 | 0.20944 | 4.60767 | 4.81711 | 0.36000 | 0.00000 | 0.00000 |
| 17 | 0.33468 | 4.81711 | 5.15179 | 0.84000 | −0.05017 | 0.47737 |
| 18 | 0.34599 | 5.15179 | 5.49779 | 0.16800 | 0.23570 | −0.13079 |
| 19 | 0.38737 | 5.49779 | 5.88516 | 0.67200 | −0.12069 | 0.22559 |
| 20 | 0.32821 | 5.88516 | 6.21337 | 0.00000 | 0.49878 | −0.03488 |

The precisely scraping screw profile of the right-hand screw element consists of the circular arcs i=1′ to 20′, which are either circular arcs or kinks. The circular arcs, start angle, end angle, arc radius relative to the housing bore inner diameter D, x-coordinate of the center of the circular arc i relative to the pivot point P₂ of the right-hand screw profile relative to the housing bore inner diameter D and y-coordinate of the center of the circular arc i relative to the pivot point P₂ of the right-hand screw profile relative to the housing bore inner diameter D are given in table 15. The crests of the precisely scraping screw profile are the circular arcs 6′ and 16′.

The sum of the crest angles of both precisely scraping screw profiles of the pair of screw elements together is BKW0=0.69814 in radians (40°).

TABLE 15
Circular arcs of the precisely scraping screw profile of
the right-hand screw element from example 4.

| i | αi | βa,i | βe,i | $\frac{{r}_{i}}{D}$ | $\frac{{xm}_{i}}{D}$ | $\frac{y {m}_{i}}{D}$ |
|---|---|---|---|---|---|---|
| 1 | 0.13963 | 3.07178 | 3.21141 | 0.34000 | 0.00000 | 0.00000 |
| 2 | 0.35741 | 3.21141 | 3.56882 | 0.84000 | 0.49878 | 0.03488 |
| 3 | 0.35817 | 3.56882 | 3.92699 | 0.16800 | −0.11282 | −0.24356 |
| 4 | 0.35817 | 3.92699 | 4.28516 | 0.67200 | 0.24356 | 0.11282 |
| 5 | 0.35741 | 4.28516 | 4.64258 | 0.00000 | −0.03488 | −0.49878 |
| 6 | 0.13963 | 4.64258 | 4.78220 | 0.50000 | 0.00000 | 0.00000 |
| 7 | 0.32821 | 4.78220 | 5.11042 | 0.00000 | 0.03488 | −0.49878 |
| 8 | 0.38737 | 5.11042 | 5.49779 | 0.67200 | −0.22559 | 0.12069 |
| 9 | 0.34599 | 5.49779 | 5.84378 | 0.16800 | 0.13079 | −0.23570 |
| 10 | 0.33468 | 5.84378 | 6.17847 | 0.84000 | −0.47737 | 0.05017 |
| 11 | 0.20944 | 6.17847 | 6.38791 | 0.36000 | 0.00000 | 0.00000 |
| 12 | 0.30458 | 6.38791 | 6.69248 | 0.84000 | −0.47737 | −0.05017 |
| 13 | 0.37610 | 6.69248 | 7.06858 | 0.16800 | 0.13912 | 0.21726 |
| 14 | 0.37610 | 7.06858 | 7.44468 | 0.67200 | −0.21726 | −0.13912 |
| 15 | 0.30458 | 7.44468 | 7.74926 | 0.00000 | 0.05017 | 0.47737 |
| 16 | 0.20944 | 7.74926 | 7.95870 | 0.48000 | 0.00000 | 0.00000 |
| 17 | 0.33468 | 7.95870 | 8.29339 | 0.00000 | −0.05017 | 0.47737 |
| 18 | 0.34599 | 8.29339 | 8.63938 | 0.67200 | 0.23570 | −0.13079 |
| 19 | 0.38737 | 8.63938 | 9.02675 | 0.16800 | −0.12069 | 0.22559 |
| 20 | 0.32821 | 9.02675 | 9.35496 | 0.84000 | 0.49878 | −0.03488 |

The technically executed, practically scraping screw elements of the inventive pair of screw elements according to example 4 with screw profiles derived from precisely scraping screw profiles are likewise asymmetrical, not congruent, but can be merged into one another by mirroring the axes and rotating them. The sum of the crest angles for both the left and the right screw profile is 0.25885 in radians (14.83°); the sum of the crest angles of the pair of screw elements is therefore BKW=0.51766 (29.66°).

The limit value calculated according to formula (2) for the sum of the crest angles of the pair of screw elements is BKGW=1.5703 in radians (89.97°). Thus BKW BKGW, their ratio

$$f = \frac{BKW}{BKGW} = 0.33 ,$$

and the screw element pair is inventive.

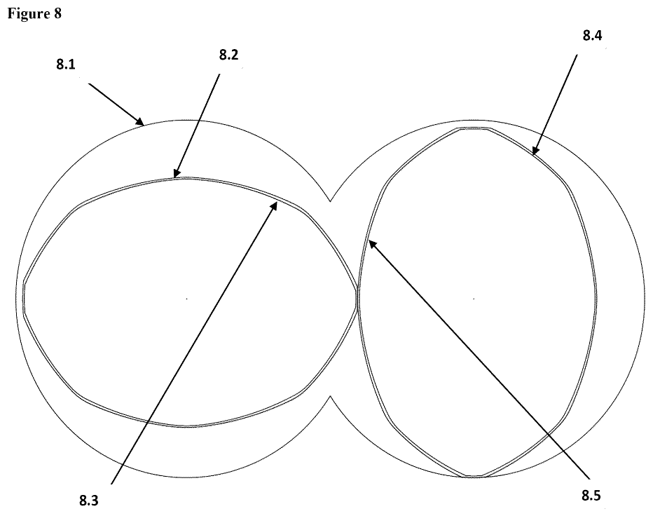

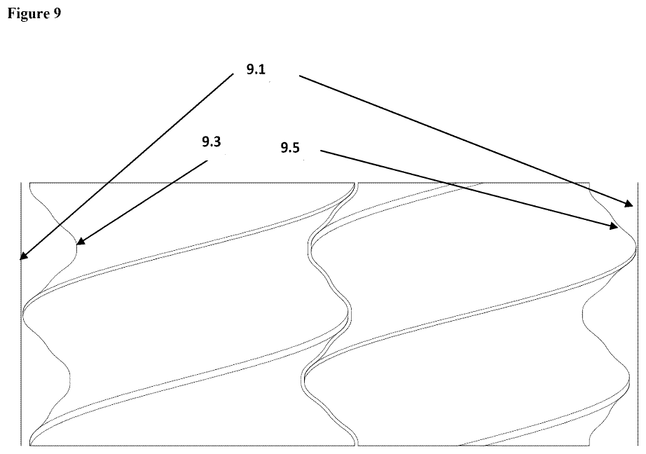

The practically scraping screw profiles of the pair of screw elements according to the invention are shown in FIG. 8, together with the corresponding precisely scraping screw profiles from which the practically scraping screw profiles were derived. FIG. 9 shows a plan view of the pair of screw elements according to the invention.

Table 16 shows the screw profile of the left-hand screw element according to formula (5). i.e. the radius as a function of the angle γₗ starting from the center of rotation P₁ of the left-hand screw profile. The radii are each given for an angular distance of two degrees, except at the transition to a crest or groove area, where additional points are given. Table 17 shows the corresponding coordinates of the screw profile of the right-hand screw profile.

TABLE 16
Screw profile of the left-hand screw element of the
pair of inventive screw elements from example 4.

| γ | r(γ)/D |
|---|---|
| 0.00 | 0.49500 |
| 2.00 | 0.49500 |
| 2.63 | 0.49500 |
| 4.00 | 0.49065 |
| 6.00 | 0.48448 |
| 8.00 | 0.47853 |
| 10.00 | 0.47282 |
| 12.00 | 0.46732 |
| 14.00 | 0.46206 |
| 16.00 | 0.45702 |
| 18.00 | 0.45220 |
| 20.00 | 0.44760 |
| 22.00 | 0.44322 |
| 24.00 | 0.43907 |
| 26.00 | 0.43512 |
| 28.00 | 0.43140 |
| 30.00 | 0.42788 |
| 30.99 | 0.42622 |
| 32.00 | 0.42442 |
| 34.00 | 0.42015 |
| 36.00 | 0.41491 |
| 38.00 | 0.40871 |
| 38.15 | 0.40821 |
| 40.00 | 0.40212 |
| 42.00 | 0.39590 |
| 44.00 | 0.39004 |
| 46.00 | 0.38453 |
| 48.00 | 0.37937 |
| 50.00 | 0.37454 |
| 52.00 | 0.37002 |
| 54.00 | 0.36582 |
| 56.00 | 0.36192 |
| 58.00 | 0.35832 |
| 60.00 | 0.35499 |
| 62.00 | 0.35195 |
| 64.00 | 0.34917 |
| 66.00 | 0.34666 |
| 68.00 | 0.34441 |
| 70.00 | 0.34241 |
| 72.00 | 0.34065 |
| 74.00 | 0.33914 |
| 76.00 | 0.33787 |
| 78.00 | 0.33683 |
| 80.00 | 0.33603 |
| 82.00 | 0.33546 |
| 84.00 | 0.33511 |
| 86.00 | 0.33500 |
| 88.00 | 0.33500 |
| 90.00 | 0.33500 |
| 92.00 | 0.33500 |
| 94.00 | 0.33500 |
| 96.00 | 0.33511 |
| 98.00 | 0.33546 |
| 100.00 | 0.33603 |
| 102.00 | 0.33683 |
| 104.00 | 0.33787 |
| 106.00 | 0.33914 |
| 108.00 | 0.34065 |
| 110.00 | 0.34241 |
| 112.00 | 0.34441 |
| 114.00 | 0.34666 |
| 116.00 | 0.34917 |
| 118.00 | 0.35195 |
| 120.00 | 0.35499 |
| 122.00 | 0.35832 |
| 124.00 | 0.36192 |
| 126.00 | 0.36582 |
| 128.00 | 0.37002 |
| 130.00 | 0.37454 |
| 132.00 | 0.37937 |
| 134.00 | 0.38453 |
| 136.00 | 0.39004 |
| 138.00 | 0.39590 |
| 138.65 | 0.39787 |
| 140.00 | 0.40183 |
| 142.00 | 0.40694 |
| 144.00 | 0.41118 |
| 146.00 | 0.41452 |
| 146.57 | 0.41530 |
| 148.00 | 0.41724 |
| 150.00 | 0.42012 |
| 152.00 | 0.42321 |
| 154.00 | 0.42650 |
| 156.00 | 0.43000 |
| 158.00 | 0.43372 |
| 160.00 | 0.43765 |
| 162.00 | 0.44180 |
| 164.00 | 0.44617 |
| 166.00 | 0.45075 |
| 168.00 | 0.45556 |
| 170.00 | 0.46060 |
| 172.00 | 0.46586 |
| 174.00 | 0.47134 |
| 175.29 | 0.47500 |
| 176.00 | 0.47500 |
| 178.00 | 0.47500 |
| 180.00 | 0.47500 |
| 182.00 | 0.47500 |
| 184.00 | 0.47500 |
| 184.79 | 0.47500 |
| 186.00 | 0.47189 |
| 188.00 | 0.46694 |
| 190.00 | 0.46220 |
| 192.00 | 0.45768 |
| 194.00 | 0.45337 |
| 196.00 | 0.44927 |
| 198.00 | 0.44539 |
| 200.00 | 0.44171 |
| 202.00 | 0.43823 |
| 204.00 | 0.43496 |
| 206.00 | 0.43189 |
| 208.00 | 0.42903 |
| 210.00 | 0.42636 |
| 212.00 | 0.42389 |
| 214.00 | 0.42161 |
| 216.00 | 0.41953 |
| 216.41 | 0.41913 |
| 218.00 | 0.41728 |
| 220.00 | 0.41411 |
| 222.00 | 0.41003 |
| 223.89 | 0.40536 |
| 224.00 | 0.40505 |
| 226.00 | 0.39986 |
| 228.00 | 0.39500 |
| 230.00 | 0.39045 |
| 232.00 | 0.38621 |
| 234.00 | 0.38228 |
| 236.00 | 0.37863 |
| 238.00 | 0.37527 |
| 240.00 | 0.37219 |
| 242.00 | 0.36938 |
| 244.00 | 0.36684 |
| 246.00 | 0.36455 |
| 248.00 | 0.36252 |
| 250.00 | 0.36074 |
| 252.00 | 0.35921 |
| 254.00 | 0.35792 |
| 256.00 | 0.35686 |
| 258.00 | 0.35605 |
| 260.00 | 0.35546 |
| 262.00 | 0.35512 |
| 264.00 | 0.35500 |
| 266.00 | 0.35500 |
| 268.00 | 0.35500 |
| 270.00 | 0.35500 |
| 272.00 | 0.35500 |
| 274.00 | 0.35500 |
| 276.00 | 0.35500 |
| 278.00 | 0.35512 |
| 280.00 | 0.35546 |
| 282.00 | 0.35605 |
| 284.00 | 0.35686 |
| 286.00 | 0.35792 |
| 288.00 | 0.35921 |
| 290.00 | 0.36074 |
| 292.00 | 0.36252 |
| 294.00 | 0.36455 |
| 296.00 | 0.36684 |
| 298.00 | 0.36938 |
| 300.00 | 0.37219 |
| 302.00 | 0.37527 |
| 304.00 | 0.37863 |
| 306.00 | 0.38228 |
| 308.00 | 0.38621 |
| 310.00 | 0.39045 |
| 312.00 | 0.39500 |
| 314.00 | 0.39986 |
| 316.00 | 0.40505 |
| 318.00 | 0.41058 |
| 319.45 | 0.41479 |
| 320.00 | 0.41640 |
| 322.00 | 0.42160 |
| 324.00 | 0.42583 |
| 326.00 | 0.42907 |
| 326.23 | 0.42937 |
| 328.00 | 0.43178 |
| 330.00 | 0.43469 |
| 332.00 | 0.43779 |
| 334.00 | 0.44110 |
| 336.00 | 0.44461 |
| 338.00 | 0.44832 |
| 340.00 | 0.45225 |
| 342.00 | 0.45638 |
| 344.00 | 0.46072 |
| 346.00 | 0.46527 |
| 348.00 | 0.47003 |
| 350.00 | 0.47501 |
| 352.00 | 0.48020 |
| 354.00 | 0.48561 |
| 356.00 | 0.49123 |
| 357.30 | 0.49500 |
| 358.00 | 0.49500 |

TABLE 17
Screw profile of the right-hand screw element of the
pair of inventive screw elements from example 4.

| γ | r(γ)/D |
|---|---|
| 0.00 | 0.35500 |
| 2.00 | 0.35500 |
| 4.00 | 0.35500 |
| 6.00 | 0.35500 |
| 8.00 | 0.35512 |
| 10.00 | 0.35546 |
| 12.00 | 0.35605 |
| 14.00 | 0.35686 |
| 16.00 | 0.35792 |
| 18.00 | 0.35921 |
| 20.00 | 0.36074 |
| 22.00 | 0.36252 |
| 24.00 | 0.36455 |
| 26.00 | 0.36684 |
| 28.00 | 0.36938 |
| 30.00 | 0.37219 |
| 32.00 | 0.37527 |
| 34.00 | 0.37863 |
| 36.00 | 0.38228 |
| 38.00 | 0.38621 |
| 40.00 | 0.39045 |
| 42.00 | 0.39500 |
| 44.00 | 0.39986 |
| 46.00 | 0.40505 |
| 46.11 | 0.40536 |
| 48.00 | 0.41003 |
| 50.00 | 0.41411 |
| 52.00 | 0.41728 |
| 53.59 | 0.41913 |
| 54.00 | 0.41953 |
| 56.00 | 0.42161 |
| 58.00 | 0.42389 |
| 60.00 | 0.42636 |
| 62.00 | 0.42903 |
| 64.00 | 0.43189 |
| 66.00 | 0.43496 |
| 68.00 | 0.43823 |
| 70.00 | 0.44171 |
| 72.00 | 0.44539 |
| 74.00 | 0.44927 |
| 76.00 | 0.45337 |
| 78.00 | 0.45768 |
| 80.00 | 0.46220 |
| 82.00 | 0.46694 |
| 84.00 | 0.47189 |
| 85.21 | 0.47500 |
| 86.00 | 0.47500 |
| 88.00 | 0.47500 |
| 90.00 | 0.47500 |
| 92.00 | 0.47500 |
| 94.00 | 0.47500 |
| 94.71 | 0.47500 |
| 96.00 | 0.47134 |
| 98.00 | 0.46586 |
| 100.00 | 0.46060 |
| 102.00 | 0.45556 |
| 104.00 | 0.45075 |
| 106.00 | 0.44617 |
| 108.00 | 0.44180 |
| 110.00 | 0.43765 |
| 112.00 | 0.43372 |
| 114.00 | 0.43000 |
| 116.00 | 0.42650 |
| 118.00 | 0.42321 |
| 120.00 | 0.42012 |
| 122.00 | 0.41724 |
| 123.43 | 0.41530 |
| 124.00 | 0.41452 |
| 126.00 | 0.41118 |
| 128.00 | 0.40694 |
| 130.00 | 0.40183 |
| 131.35 | 0.39787 |
| 132.00 | 0.39590 |
| 134.00 | 0.39004 |
| 136.00 | 0.38453 |
| 138.00 | 0.37937 |
| 140.00 | 0.37454 |
| 142.00 | 0.37002 |
| 144.00 | 0.36582 |
| 146.00 | 0.36192 |
| 148.00 | 0.35832 |
| 150.00 | 0.35499 |
| 152.00 | 0.35195 |
| 154.00 | 0.34917 |
| 156.00 | 0.34666 |
| 158.00 | 0.34441 |
| 160.00 | 0.34241 |
| 162.00 | 0.34065 |
| 164.00 | 0.33914 |
| 166.00 | 0.33787 |
| 168.00 | 0.33683 |
| 170.00 | 0.33603 |
| 172.00 | 0.33546 |
| 174.00 | 0.33511 |
| 176.00 | 0.33500 |
| 178.00 | 0.33500 |
| 180.00 | 0.33500 |
| 182.00 | 0.33500 |
| 184.00 | 0.33500 |
| 186.00 | 0.33511 |
| 188.00 | 0.33546 |
| 190.00 | 0.33603 |
| 192.00 | 0.33683 |
| 194.00 | 0.33787 |
| 196.00 | 0.33914 |
| 198.00 | 0.34065 |
| 200.00 | 0.34241 |
| 202.00 | 0.34441 |
| 204.00 | 0.34666 |
| 206.00 | 0.34917 |
| 208.00 | 0.35195 |
| 210.00 | 0.35499 |
| 212.00 | 0.35832 |
| 214.00 | 0.36192 |
| 216.00 | 0.36582 |
| 218.00 | 0.37002 |
| 220.00 | 0.37454 |
| 222.00 | 0.37937 |
| 224.00 | 0.38453 |
| 226.00 | 0.39004 |
| 228.00 | 0.39590 |
| 230.00 | 0.40212 |
| 231.85 | 0.40821 |
| 232.00 | 0.40871 |
| 234.00 | 0.41491 |
| 236.00 | 0.42015 |
| 238.00 | 0.42442 |
| 239.01 | 0.42622 |
| 240.00 | 0.42788 |
| 242.00 | 0.43140 |
| 244.00 | 0.43512 |
| 246.00 | 0.43907 |
| 248.00 | 0.44322 |
| 250.00 | 0.44760 |
| 252.00 | 0.45220 |
| 254.00 | 0.45702 |
| 256.00 | 0.46206 |
| 258.00 | 0.46732 |
| 260.00 | 0.47282 |
| 262.00 | 0.47853 |
| 264.00 | 0.48448 |
| 266.00 | 0.49065 |
| 267.37 | 0.49500 |
| 268.00 | 0.49500 |
| 270.00 | 0.49500 |
| 272.00 | 0.49500 |
| 272.70 | 0.49500 |
| 274.00 | 0.49123 |
| 276.00 | 0.48561 |
| 278.00 | 0.48020 |
| 280.00 | 0.47501 |
| 282.00 | 0.47003 |
| 284.00 | 0.46527 |
| 286.00 | 0.46072 |
| 288.00 | 0.45638 |
| 290.00 | 0.45225 |
| 292.00 | 0.44832 |
| 294.00 | 0.44461 |
| 296.00 | 0.44110 |
| 298.00 | 0.43779 |
| 300.00 | 0.43469 |
| 302.00 | 0.43178 |
| 303.77 | 0.42937 |
| 304.00 | 0.42907 |
| 306.00 | 0.42583 |
| 308.00 | 0.42160 |
| 310.00 | 0.41640 |
| 310.55 | 0.41479 |
| 312.00 | 0.41058 |
| 314.00 | 0.40505 |
| 316.00 | 0.39986 |
| 318.00 | 0.39500 |
| 320.00 | 0.39045 |
| 322.00 | 0.38621 |
| 324.00 | 0.38228 |
| 326.00 | 0.37863 |
| 328.00 | 0.37527 |
| 330.00 | 0.37219 |
| 332.00 | 0.36938 |
| 334.00 | 0.36684 |
| 336.00 | 0.36455 |
| 338.00 | 0.36252 |
| 340.00 | 0.36074 |
| 342.00 | 0.35921 |
| 344.00 | 0.35792 |
| 346.00 | 0.35686 |
| 348.00 | 0.35605 |
| 350.00 | 0.35546 |
| 352.00 | 0.35512 |
| 354.00 | 0.35500 |
| 356.00 | 0.35500 |
| 358.00 | 0.35500 |

### BRIEF DESCRIPTION OF FIGURES AND LIST OF REFERENCE SIGNS

### FIG. 1

Practically scraping screw profile of the left-hand screw element from example 2
1.1 Housing bore inner wall profile of the left part of the housing bore
1.2 Flight depth GT
1.3 Housing bore inner diameter D
1.4 Crest angle of the left-hand screw element, which has a screw element-to-housing wall clearance δ, but not an additional gap SP: KW_{l,δ}
1.5 Screw element-to-housing wall clearance δ
1.6 Flight depth reduced by the additional gap: GT−SP
1.7 Screw element-to-housing wall clearance increased by the additional gap: δ+SP
1.8 Crest angle of the left-hand screw element, which has both a screw element-to-housing wall clearance δ and an additional gap SP: KW_{l,δ+SP}
1.9 Center of rotation P

### FIG. 2

Screw profiles of the pair of screw elements not according to the invention from example 1
2.1 Housing bore inner wall profile
2.2 Profile left-hand screw element, precisely scraping
2.3 Profile left-hand screw element, practically scraping
2.4 Profile right-hand screw element, precisely scraping
2.5 Profile right-hand screw element, practically scraping

### FIG. 3

Plan view of the screw element pair not according to the invention from example 1
3.1 Housing bore inner wall profile
3.3 Profile left-hand screw element, practically scraping
3.5 Profile right-hand screw element, practically scraping

### FIG. 4

Screw profiles of the screw element pair according to the invention from example 2
4.1 Housing bore inner wall profile
4.2 Profile left-hand screw element, precisely scraping
4.3 Profile left-hand screw element, practically scraping
4.4 Profile right-hand screw element, precisely scraping
4.5 Profile right-hand screw element, practically scraping

### FIG. 5

Plan view of the screw element pair according to the invention from example 2
5.1 Housing bore inner wall profile
5.3 Profile left-hand screw element, practically scraping
5.5 Profile right-hand screw element, practically scraping

### FIG. 6

Screw profiles of the screw element pair according to the invention from example 3
6.1 Housing bore inner wall profile
6.2 Profile left-hand screw element, precisely scraping
6.3 Profile left-hand screw element, practically scraping
6.4 Profile right-hand screw element, precisely scraping
6.5 Profile right-hand screw element, practically scraping

### FIG. 7

Plan view of the screw element pair according to the invention from example 3
7.1 Housing bore inner wall profile
7.3 Profile left-hand screw element, practically scraping
7.5 Profile right-hand screw element, practically scraping

### FIG. 8

Screw profiles of the screw element pair according to the invention from example 4
8.1 Housing bore inner wall profile
8.2 Profile left-hand screw element, precisely scraping
8.3 Profile left-hand screw element, practically scraping
8.4 Profile right-hand screw element, precisely scraping
8.5 Profile right-hand screw element, practically scraping

### FIG. 9

Plan view of the screw element pair according to the invention from example 4
9.1 Housing bore inner wall profile
9.3 Profile left-hand screw element, practically scraping
9.5 Profile right-hand screw element, practically scraping

1. A multishaft screw machine having a pair of screw elements, comprising:
m screw shafts SW₁ to SWₘ rotating in the same direction and at the same speed, the respective neighboring axes of rotation X₁ to Xₘ of which have a center distance A in a cross-section at right angles to the axes of rotation; and
m interpenetrating circular housing bores which each have an identical housing bore inner diameter D and of which the bore centers M₁ to Mₘ have a distance equal to the center distance A, and of which the bore centers M₁ to Mₘ coincide with the respective associated axes of rotation X₁ to Xₘ of the screw shafts SW₁ to SWₘ and coincide with the centers of rotation P₁ to Pₘ of the screw elements,
wherein the two screw elements of the pair of screw elements lie opposite each other on directly neighboring screw shafts,
the two screw elements of the pair of screw elements scraping each other with a screw element-to-screw element clearance s,
wherein both screw elements have an asymmetrical screw profile,
wherein both screw elements each have exactly two crests,
wherein for each of the two screw elements, the two crests have different distances to the respective center of rotation P of the screw profile,
wherein in each case one crest has a distance D/2 reduced by a screw element-to-housing wall clearance δ and further reduced by an additional gap SP to the respective center of rotation P and the other crest has a distance D/2 reduced by a screw element-to-housing wall clearance δ, but not reduced by an additional gap SP, to the respective center of rotation P,
wherein the screw element-to-housing wall clearance δ is the same for both screw elements and the additional gap SP is the same for both screw elements,
wherein the sum of the crest angles BKW of the crests of both screw elements in radians is greater than 0, and
for the factor f with
$$f = BKW / BKGW \qquad ( 44 )$$
it is true that the factor f is greater than 0 and less than or equal to 0.95,
wherein BKW is the sum of the crest angles in radians of both screw elements and BKGW is determined by:
$$BKGW = 2 ( π - \frac{1}{2} ( arccos ( \frac{{A}^{2} - 2 {RE}^{2}}{2 {RE}^{2}} ) + arccos ( \frac{{A}^{2} - 2 {RE}^{2} + 2 RE SP - {SP}^{2}}{2 RE ( RE - SP )} ) + arccos ( \frac{{A}^{2} - 2 {( RE - SP )}^{2}}{2 {( RE - SP )}^{2}} ) + arccos ( \frac{{A}^{2} - 2 {RE}^{2} + 2 RE SP - {SP}^{2}}{2 RE ( RE - SP )} ) ) - \frac{s}{T} ( 26.22113 - 16.0 \; 3623 \frac{A}{D} - 30.9 \; 465 \frac{δ}{D} + 14.5 \; 763 \frac{s}{D} - 0.20071 \frac{T}{D} - 0.0 \; 0475 \frac{SP}{GT} + 4.8 \; 9626 erf ( - 0.8 \; 55 \frac{T}{D} ) ) ) , \qquad ( 45 )$$

2. The multishaft screw machine as claimed in claim 1, wherein the factor f is greater than or equal to 0.1 and less than or equal to 0.8.

3. The multishaft screw machine as claimed in claim 1, wherein the ratio of the screw element-to-screw element clearance s between the two screw elements of a pair of screw elements to the housing bore inner diameter D is in a range of from 0.002 to 0.05.

4. The multishaft screw machine as claimed in claim 1, wherein the screw element-to-housing wall clearance δ in relation to the housing bore inner diameter D is in a range of 0.002 to 0.05.

5. The multishaft screw machine as claimed in claim 1, wherein the additional gap SP in relation to the flight depth GT of the respective screw element is in a range of 0.015 to 0.4.

6. The multishaft screw machine as claimed in claim 1, wherein the crest angles of the crests of the pair of screw elements which have the screw element-to-housing wall clearance δ but not the additional gap SP to the housing bore inner wall are the same.

7. The multishaft screw machine as claimed in claim 1, wherein the crest angles of the crests of the pair of screw elements having the screw element-to-housing wall δ clearance and the additional gap SP to the housing bore inner wall are the same.

8. The multishaft screw machine as claimed in claim 1, wherein for both screw elements of the pair of screw elements, the crest angles of the crests of the screw elements of the pair of screw elements which have the screw element-to-housing wall clearance δ and the additional gap SP are greater than the crest angles of the crests of the screw elements of the pair of screw elements that have the screw element-to-housing wall clearance δ, but not the additional gap SP.

9. The multishaft screw machine as claimed in claim 1, wherein the screw profiles of the pair of screw elements are not congruent, and wherein the screw profiles of the two screw elements are able to be merged into one another by mirroring the axes and rotating them.

10. The multishaft screw machine as claimed in claim 1, wherein each of the two screw profiles of the pair of screw elements has exactly two grooves and exactly four flanks.

11. The multishaft screw machine as claimed in claim 1, wherein the two screw profiles of the pair of screw elements has exactly four (4) grooves and exactly eight (8) flanks.

12. A method for producing an extrudate using the multishaft screw machine as claimed in claim 1, the method comprising the steps of:
(1) providing the multishaft screw machine; and
(2) producing the extrudate.

13. The multishaft screw machine as claimed in claim 2, wherein the factor f is greater than or equal to 0.2 and less than or equal to 0.6.

14. The multishaft screw machine as claimed in claim 3, wherein the ratio of the screw element-to-screw element clearance s between the two screw elements of a pair of screw elements to the housing bore inner diameter D is in a range of 0.005 to 0.02.

15. The multishaft screw machine as claimed in claim 4, wherein the screw element-to-housing wall clearance δ in relation to the housing bore inner diameter D is in a range of 0.005 to 0.02.

16. The multishaft screw machine as claimed in claim 5, wherein the additional gap SP in relation to the flight depth GT of the respective screw element is in a range of 0.025 to 0.25.
